(19) United States
(12) Patent Application Publication
(10) Pub. No.: US 2026/0284646 A1
(43) Pub. Date: Sep. 24, 2026

(54) MODIFIED COPPER ZEOLITES AND METHOD OF USING THE SAME FOR TREATMENT OF GAS STREAMS CONTAINING NOX

(71) Applicant: BASF CORPORATION, Florham Park, NJ (US)

(72) Inventors: Matthew T. CAUDLE, Iselin, NJ (US); Vivek VATTIPALLI, Iselin, NJ (US); YuFen HAO, Iselin, NJ (US)

(21) Appl. No.: 19/469,763

(22) PCT Filed: Apr. 5, 2024
(86) PCT No.: PCT/US2024/023251

§ 371 Date: Sep. 26, 2025

Related U.S. Application Data
(60) Provisional application No. 63/457,591, filed on Apr. 6, 2023.

(51) Int. Cl. B01J 29/76; B01D 53/94; B01J 35/56; B01J 37/02

(52) U.S. Cl. CPC B01J 29/763; B01D 53/9413; B01J 35/56; B01J 37/0246; B01D 2255/50; B01D 2255/9155; B01D 2258/01

(57) ABSTRACT

The present disclosure generally provides catalyst compositions which may be useful for selective catalytic reduction. The catalyst compositions may include a zeolite which includes copper and at least one additional metal. Methods of decreasing the amount of NOₓ in a gas stream and an exhaust gas treatment system, which may employ the catalyst compositions described herein, are also described.

### FIELD

The present disclosure relates to zeolite catalyst compositions for use in selective catalytic reduction (SCR) to reduce nitrogen oxides with minimal undesirable side products. Methods of treating a gas stream with such catalyst compositions, and an exhaust gas treatment system containing such catalyst compositions, are also disclosed.

### BACKGROUND

The harmful components of nitrogen oxides (NOₓ) are known to contribute to atmospheric pollution. NOₓ is contained in exhaust gases, such as those from internal combustion engines (for example, in vehicles), combustion installations (for example, thermal power stations heated by natural gas, oil, or coal), and nitric acid production plants. Particularly challenging are modern diesel engines, which operate with high compression ratios and burn fuel at high temperatures, thereby generating NOₓ emissions.

Various treatment methods have been used for the treatment of gas streams which contain NOₓ to decrease atmospheric pollution. One such treatment involves catalytic reduction of nitrogen oxides to form nitrogen gas and water. There are two processes: (1) a non-selective reduction process wherein carbon monoxide, hydrogen, or a lower molecular weight hydrocarbon is used as a reducing agent; and (2) a selective reduction process wherein ammonia or an ammonia precursor is used as a reducing agent. In the selective reduction process, a high degree of nitrogen oxide removal can be achieved with a small stoichiometric amount of reducing agent.

The selective reduction process is referred to as a SCR (Selective Catalytic Reduction) process. The SCR process uses catalytic reduction of nitrogen oxides with a reductant (for example, ammonia) in the presence of excess oxygen, resulting in the formation predominantly of nitrogen and steam:

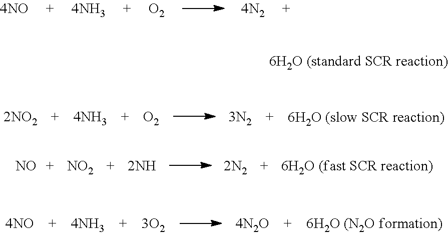

In some cases, N₂O is formed as a side product of SCR. N₂O is a greenhouse gas and emissions thereof are subject to regulations; accordingly, it is desirable to minimize the formation of N₂O during SCR. It is thus advantageous to identify SCR catalysts which provide strong NOₓ conversion with minimal N₂O formation.

Catalysts employed in the SCR process ideally should be able to retain good catalytic activity over a wide range of temperature conditions of use, for example, 200° C. to 600° C. or higher, after aging under hydrothermal conditions. SCR catalysts used in exhaust emission control applications are exposed to high temperature hydrothermal conditions during the regeneration of a soot filter, a component of the exhaust gas treatment system used for the removal of particles. Molecular sieves such as zeolites have been used in the selective catalytic reduction (SCR) of nitrogen oxides with a reductant such as ammonia, urea, or a hydrocarbon in the presence of oxygen. Zeolites are crystalline materials having uniform pore sizes which, depending upon the type of zeolite and the type and amount of cations included in the zeolite lattice, range from about 3 to about 10 Angstroms in diameter. Zeolites having 8-ring pore openings and double-six ring secondary building units, particularly those having cage-like structures, have recently been studied for use as SCR catalysts. A specific type of zeolite having these properties is chabazite (CHA), which is a small pore zeolite with 8 member-ring pore openings (~3.8 Angstroms) accessible through its 3-dimensional porosity. A cage-like structure results from the connection of double six-ring units by 4 rings.

Metal-promoted zeolite catalysts including, among others, iron-promoted and copper-promoted zeolite catalysts, are known for the selective catalytic reduction of nitrogen oxides with ammonia. There is always a desire for improved performance of catalysts and, accordingly, it would be beneficial to provide SCR catalysts with improved NOₓ conversion performance and decreased formation of N₂O.

### SUMMARY

In some aspects, the techniques described herein relate to a catalyst composition including: a zeolite having: a total amount of aluminum in sites T₍ₙ₎ with n≥2 of about 0.05 mequiv/g to about 5 mequiv/g, a silica to alumina ratio (SAR) of about 5 to about 120, copper, and at least one additional metal that is not copper, wherein the additional metal has a charge to radius ratio (Z/r) of about 1.2 to about 3.0, and wherein the additional metal is not sodium or potassium, wherein the zeolite has a copper content between about 0.05 mequiv/g and about 5.0 mequiv/g on a Cu²⁺ basis, and wherein the copper loading in mequiv/g on a Cu²⁺ basis is less than the total amount of aluminum equivalents in sites T₍ₙ₎ with n≥2, and wherein, the loading of the additional metal is chosen such that the total metal loading in mequiv/g is less than or equal to the total amount of aluminum equivalents in sites T₍ₙ₎ with n≥1.

In some aspects, the techniques described herein relate to a catalyst composition, wherein the loading of the additional metal is chosen such that the total metal loading in mequiv/g is less than or equal to the total amount of aluminum equivalents in sites T₍ₙ₎ with n≥2.

In some aspects, the techniques described herein relate to a catalyst composition, wherein the loading of the additional metal is chosen such that the total metal loading in mequiv/g is substantially equal to the total amount of aluminum equivalents in sites T₍ₙ₎ with n≥2.

In some aspects, the techniques described herein relate to a catalyst composition, wherein the copper and at least one additional metal ion are added to the zeolite by an ion-exchange process.

In some aspects, the techniques described herein relate to a catalyst composition, wherein the copper and at least one additional metal ion are added to the zeolite by a co-exchange process.

In some aspects, the techniques described herein relate to a catalyst composition, wherein the additional metal has a charge-to-radius ratio (Z/r) of about 2.0 to 2.5.

In some aspects, the techniques described herein relate to a catalyst composition, wherein the additional metal has a charge-to-radius ratio (Z/r) of about 2.2 to about 2.4.

In some aspects, the techniques described herein relate to a catalyst composition, wherein the additional metal comprises magnesium, calcium, strontium, barium, chromium, manganese, iron, cobalt, nickel, zinc, or combinations thereof.

In some aspects, the techniques described herein relate to a catalyst composition, wherein the zeolite has an SAR of about 10 to about 50.

In some aspects, the techniques described herein relate to a catalyst composition, wherein the zeolite has an SAR of about 15 to about 40.

In some aspects, the techniques described herein relate to a catalyst composition, wherein the zeolite is a small-pore zeolite, a medium-pore zeolite, or a large-pore zeolite.

In some aspects, the techniques described herein relate to a catalyst composition, wherein the zeolite is a 10-ring zeolite or a 12-ring zeolite.

In some aspects, the techniques described herein relate to a catalyst composition, wherein the zeolite has a framework structure selected from AEI, AFT, CHA, LTA, AFX, ERI, UFI, KFI, AFV, AVL, SFW, SWY, or mixtures and/or intergrowths comprising one or more of these.

In some aspects, the techniques described herein relate to a catalyst composition, wherein the zeolite has a framework structure selected from MFI, MWW, FER, MSE, YFI, or mixtures and/or intergrowths comprising one or more of these.

In some aspects, the techniques described herein relate to a catalyst composition, wherein the zeolite has a framework structure selected from FAU, BEA, or mixtures and/or intergrowths comprising one or more of these.

In some aspects, the techniques described herein relate to a catalyst composition, wherein the zeolite is CHA.

In some aspects, the techniques described herein relate to a catalyst composition, wherein the catalyst composition is coated onto a monolithic substrate in a washcoat layer where the substrate is a metallic, cordierite, or silicon carbide (SiC) substrate.

In some aspects, the techniques described herein relate to a catalyst composition, wherein the substrate is a flow-through substrate or a wall-flow substrate.

In some aspects, the techniques described herein relate to a catalyst composition, wherein the amount of the catalyst composition in the washcoat layer is between about 0.1 g/in³ and about 5.0 g/in³ based on a bulk volume of the substrate.

In some aspects, the techniques described herein relate to a catalyst composition, wherein the catalyst composition gives a conversion of NOₓ of at least 80% at a space velocity of 60,000 h⁻¹ a temperature greater than 250° C., after aging at a temperature greater than or equal to 550° C., and results in the conversion of less than 1.0% of NO to N₂O at a temperature less than 400° C. when the catalyst composition is used for selective catalytic reduction.

In some aspects, the techniques described herein relate to a method for decreasing the amount of NOₓ in a gas stream which contains NOₓ, including: contacting the gas stream with a catalyst composition including: a zeolite having: a total amount of aluminum in sites T₍ₙ₎ with n≥2 of about 0.05 mequiv/g to about 5 mequiv/g, a silica to alumina ratio (SAR) of about 5 to about 120, copper, and at least one additional metal that is not copper, wherein the additional metal has a charge to radius ratio (Z/r) of about 1.2 to about 3.0, and wherein the additional metal is not sodium or potassium, wherein the zeolite has a copper content between about 0.05 mequiv/g and about 5.0 mequiv/g on a Cu²⁺ basis, and wherein the copper loading in mequiv/g on a Cu²⁺ basis is less than the total amount of aluminum equivalents in sites T₍ₙ₎ with n≥2, and wherein, the loading of the additional metal is chosen such that the total metal loading in mequiv/g is less than or equal to the total amount of aluminum equivalents in sites T₍ₙ₎ with n≥1.

In some aspects, the techniques described herein relate to a method, wherein the loading of the additional metal is chosen such that the total metal loading in mequiv/g is less than or equal to the total amount of aluminum equivalents in sites T₍ₙ₎ with n≥2.

In some aspects, the techniques described herein relate to a method, wherein the loading of the additional metal is chosen such that the total metal loading in mequiv/g is substantially equal to the total amount of aluminum equivalents in sites T₍ₙ₎ with n≥2.

In some aspects, the techniques described herein relate to a method, wherein the copper and at least one additional metal ion are added to the zeolite by an ion-exchange process.

In some aspects, the techniques described herein relate to a method, wherein the copper and at least one additional metal ion are added to the zeolite by a co-exchange process.

In some aspects, the techniques described herein relate to a method, wherein the additional metal has a charge-to-radius ratio (Z/r) of about 2.0 to 2.5.

In some aspects, the techniques described herein relate to a method, wherein the additional metal has a charge-to-radius ratio (Z/r) of about 2.2 to about 2.4.

In some aspects, the techniques described herein relate to a method, wherein the additional metal comprises magnesium, calcium, strontium, barium, chromium, manganese, iron, cobalt, nickel, zinc, or combinations thereof.

In some aspects, the techniques described herein relate to a method, wherein the zeolite has an SAR of about 10 to about 50.

In some aspects, the techniques described herein relate to a method, wherein the zeolite has an SAR of about 15 to about 40.

In some aspects, the techniques described herein relate to a method, wherein the zeolite is a small-pore zeolite, a medium-pore zeolite, or a large-pore zeolite.

In some aspects, the techniques described herein relate to a method, wherein the zeolite is a 10-ring zeolite or a 12-ring zeolite.

In some aspects, the techniques described herein relate to a method, wherein the zeolite has a framework structure selected from AEI, AFT, CHA, LTA, AFX, ERI, UFI, KFI, AFV, AVL, SFW, SWY, or mixtures and/or intergrowths comprising one or more of these.

In some aspects, the techniques described herein relate to a method, wherein the zeolite has a framework structure selected from MFI, MWW, FER, MSE, YFI, or mixtures and/or intergrowths comprising one or more of these.

In some aspects, the techniques described herein relate to a method, wherein the zeolite has a framework structure selected from FAU, BEA, or mixtures and/or intergrowths comprising one or more of these.

In some aspects, the techniques described herein relate to a method, wherein the zeolite is CHA.

In some aspects, the techniques described herein relate to a method, wherein the catalyst composition is coated onto a monolithic substrate in a washcoat layer where the substrate is a metallic, cordierite, or silicon carbide (SiC) substrate.

In some aspects, the techniques described herein relate to a method, wherein the substrate is a flow-through substrate or a wall-flow substrate.

In some aspects, the techniques described herein relate to a method, wherein the amount of the catalyst composition in the washcoat layer is between about 0.1 g/in³ and about 5.0 g/in³ based on the bulk volume of the substrate.

In some aspects, the techniques described herein relate to the method, wherein the catalyst composition gives a conversion of NOₓ of at least 80% at a space velocity of 60,000 h⁻¹ and a temperature greater than 250° C., after aging at a temperature greater than or equal to 550° C., and results in the conversion of less than 1.0% of NO to N₂O at a temperature less than 400° C. when the catalyst composition is used for selective catalytic reduction.

In some aspects, the techniques described herein relate to an exhaust gas treatment system including: an NOₓ generator which produces an exhaust gas stream containing NOₓ, a catalyst composition including a zeolite having: a total amount of aluminum in sites T₍ₙ₎ with n≥2 of about 0.05 mequiv/g to about 5 mequiv/g, a silica to alumina ratio (SAR) of about 5 to about 120, copper, and at least one additional metal that is not copper, wherein the additional metal has a charge to radius ratio (Z/r) of about 1.2 to about 3.0, and wherein the additional metal is not sodium or potassium, wherein the zeolite has a copper content between about 0.05 mequiv/g and about 5.0 mequiv/g on a Cu²⁺ basis, and wherein the copper loading in mequiv/g on a Cu²⁺ basis is less than the total amount of aluminum equivalents in sites T₍ₙ₎ with n≥2, and wherein, the loading of the additional metal is chosen such that the total metal loading in mequiv/g is less than or equal to the total amount of aluminum equivalents in sites T(n) with n≥1. an injector configured to inject a reducing agent to the exhaust gas stream, wherein the catalyst composition is in fluid communication with the exhaust gas stream, wherein the reducing agent and the catalyst composition promote the conversion of NOₓ to a composition including N₂ and water, wherein the catalyst composition gives a conversion of NOₓ of at least 80% at a space velocity of 60,000 h⁻¹ and a temperature greater than 250° C., after aging at a temperature greater than or equal to 550° C., and results in the conversion of less than 1.0% of NO to N₂O at a temperature less than 400° C. when the catalyst composition is used for selective catalytic reduction.

In some aspects, the techniques described herein relate to an exhaust gas treatment system, wherein the NOₓ generator is an internal combustion engine, an external combustion engine, or a chemical reactor.

In some aspects, the techniques described herein relate to an exhaust gas treatment system, wherein the catalyst composition is in a close-coupled position.

In some aspects, the techniques described herein relate to an exhaust gas treatment system, wherein the loading of the additional metal is chosen such that the total metal loading in mequiv/g is less than or equal to the total amount of aluminum equivalents in sites T₍ₙ₎ with n≥2.

In some aspects, the techniques described herein relate to an exhaust gas treatment system, wherein the loading of the additional metal is chosen such that the total metal loading in mequiv/g is substantially equal to the total amount of aluminum equivalents in sites T₍ₙ₎ with n≥2.

In some aspects, the techniques described herein relate to an exhaust gas treatment system, wherein the copper and at least one additional metal ion are added to the zeolite by an ion-exchange process.

In some aspects, the techniques described herein relate to an exhaust gas treatment system, wherein the copper and at least one additional metal ion are added to the zeolite by a co-exchange process.

In some aspects, the techniques described herein relate to an exhaust gas treatment system, wherein the additional metal has a charge-to-radius ratio (Z/r) of about 2.0 to 2.5.

In some aspects, the techniques described herein relate to an exhaust gas treatment system, wherein the additional metal has a charge-to-radius ratio (Z/r) of about 2.2 to about 2.4.

In some aspects, the techniques described herein relate to an exhaust gas treatment system, wherein the additional metal includes magnesium, calcium, strontium, barium, chromium, manganese, iron, cobalt, nickel, zinc, or combinations thereof.

In some aspects, the techniques described herein relate to an exhaust gas treatment system, wherein the zeolite has an SAR of about 10 to about 50.

In some aspects, the techniques described herein relate to an exhaust gas treatment system, wherein the zeolite has an SAR of about 15 to about 40.

In some aspects, the techniques described herein relate to an exhaust gas treatment system, wherein the zeolite is a small-pore zeolite, a medium-pore zeolite, or a large-pore zeolite.

In some aspects, the techniques described herein relate to an exhaust gas treatment system, wherein the zeolite is a 10-ring zeolite or a 12-ring zeolite.

In some aspects, the techniques described herein relate to an exhaust gas treatment system, wherein the zeolite has a framework structure selected from AEI, AFT, CHA, LTA, AFX, ERI, UFI, KFI, AFV, AVL, SFW, SWY, or mixtures and/or intergrowths comprising one or more of these.

In some aspects, the techniques described herein relate to an exhaust gas treatment system, wherein the zeolite has a framework structure selected from MFI, MWW, FER, MSE, YFI, or mixtures and/or intergrowths comprising one or more of these.

In some aspects, the techniques described herein relate to an exhaust gas treatment system, wherein the zeolite has a framework structure selected from FAU, BEA, or mixtures and/or intergrowths comprising one or more of these.

In some aspects, the techniques described herein relate to an exhaust gas treatment system, wherein the zeolite is CHA.

In some aspects, the techniques described herein relate to an exhaust gas treatment system, wherein the zeolite is coated onto a monolithic substrate in a washcoat layer where the substrate is a metallic, cordierite, or silicon carbide (SiC) substrate.

In some aspects, the techniques described herein relate to an exhaust gas treatment system, wherein the substrate is a flow-through substrate or a wall-flow substrate.

In some aspects, the techniques described herein relate to an exhaust gas treatment system, wherein the amount of the catalyst composition in the washcoat layer is between about 0.1 g/in³ and about 5.0 g/in³ based on the bulk volume of the substrate.

In some aspects, the techniques described herein relate to an exhaust gas treatment system, wherein the catalyst composition gives a conversion of NOₓ of at least 85% at a space velocity of 60,000 h⁻¹ and a temperature greater than 250° C., after aging at a temperature greater than or equal to 550° C., and results in the conversion of less than 1.0% of NO to N₂O at a temperature less than 400° C. when the catalyst composition is used for selective catalytic reduction.

### DRAWINGS

Aspects, features, benefits, and advantages of the embodiments described herein will be apparent with regard to the following description, appended claims, and accompanying drawings where:

FIG. 1 is a drawing of the configuration around different tetrahedral sites in the zeolite framework illustrating T₍ₙ₎ sites, where n represents the number of nearest-neighbor tetrahedral sites occupied by aluminum atoms.

FIG. 2 is a graph of the ion-exchange capacity available in each site T₍ₙ₎ and the sum of ion-exchange capacity available in sites T₍₂₋₄₎, at different SAR, assuming a randomized distribution of Al atoms.

FIG. 3 is a graph of the N₂O formation and NOₓ conversion of a selection of example catalyst compositions, according to embodiments described herein.

FIG. 4 is a graph of the N₂O formation and NOₓ conversion of a selection of example catalyst compositions, according to embodiments described herein.

FIG. 5 is a graph of NOₓ conversion and N₂O formation of a selection of example catalyst compositions containing different amounts of magnesium, according to embodiments described herein.

FIG. 6 is a graph of NOₓ conversion and N₂O formation of a selection of catalyst compositions containing different amounts of zinc, according to embodiments described herein.

FIG. 7 is a graph of NOₓ conversion of a selection of example catalysts compositions at different SAR coated onto ceramic monoliths and aged at increasingly severe conditions, according to embodiments described herein.

FIG. 8 is a graph of NOₓ conversion and N₂O formation of a selection of catalyst compositions aged at 650° C. for 50 hr in 10% H₂O/air, according to embodiments described herein.

FIG. 9 is a graph of NOₓ conversion and N₂O formation of a selection of catalyst compositions containing different amounts of copper coated onto ceramic monoliths and aged at 650° C. for 50 hr in 10% H₂O/air, according to embodiments described herein.

FIG. 10 is a graph of N₂O formation and NOₓ conversion of a selection of catalyst compositions coated onto ceramic monoliths, aged at 650° C. for 50 hr in 10% H₂O/air, and evaluated with NO₂/NOₓ=0 or 0.5, according to embodiments described herein.

FIG. 11 is a graph of N₂O formation and NOₓ conversion of a selection of catalyst compositions coated onto ceramic monoliths, aged at 650° C. for 50 hr in 10% H₂O/air, and evaluated with NO₂/NOₓ=0 or 0.5, according to embodiments described herein.

FIG. 12 is a chart of NOₓ conversion and N₂O selectivity of a selection of catalyst compositions coated onto ceramic monoliths, aged at 650° C. for 50 hr in 10% H₂O/air, according to embodiments described herein.

FIG. 13 is a chart of ΔdeNOₓ (NOₓ conversion in degreened state—NOₓ conversion in aged state) and N₂O selectivity after aging of a selection of catalyst compositions coated onto ceramic monoliths, according to embodiments described herein.

### DETAILED DESCRIPTION

The present disclosure describes catalyst compositions for use in selective catalytic reduction of nitrogen oxides. The catalyst compositions generally include modified zeolites and can provide effective reduction of nitrogen oxides with minimal formation of unwanted side products.

In some embodiments, there is provided a catalyst composition including a zeolite having: a total amount of aluminum in sites T₍ₙ₎ with n≥2 of about 0.05 mequiv/g to about 5 mequiv/g, a silica to alumina ration (SAR) of about 5 to about 100, copper, and at least one additional metal. The zeolite may have a copper content between about 0.05 mequiv/g and about 5.0 mequiv/g on a Cu²⁺ basis. The additional metal is, in some embodiments a metal having a charge to radius ratio (Z/r) of about 1.2 to about 3.0, wherein the additional metal is not sodium or potassium. The catalyst composition of the present disclosure has a copper loading, in mequiv/g on Cu²⁺ basis, that is less than the total amount of aluminum in sites T₍ₙ₎ with n≥2. The loading of the additional metal in the catalyst composition is chosen such that the total loading in mequiv/g is less than or equal to the total amount of aluminum in sites T₍ₙ₎ with n≥2.

The following terms shall have, for the purposes of this application, the respective meanings set forth below.

As used herein, the term “mequiv” means milliequivalent(s). A milliequivalent is one-thousandth of an equivalent, wherein, for the purposes of this disclosure, an equivalent refers to an ion-exchange equivalent. Substitution of a single silicon atom by a single aluminum atom in the zeolite framework creates one ion-exchange equivalent. Therefore, a zeolite containing 1.0 mmol/g aluminum in the framework contains 1.0 mequiv/g of ion-exchange equivalent. The amount of ion-exchanged metal in a zeolite can be defined in terms of the number of ion-exchange equivalents it can compensate. For a given metal ion, the number of ion-exchange equivalents (in units of mequiv/g) is defined as the product Z×C where Z is the electronic charge on the metal ion (in units of elementary electron charge) and C is the concentration of metal ion in the zeolite (in units of mmol/g). For example, a zeolite containing 1.0 mmol/g of copper will contain 2.0 mequiv/g of copper on a Cu²⁺ basis.

As used herein, the term “selective catalytic reduction” which may be abbreviated as “SCR” refers to any catalytic process involving the reaction of nitrogen oxides (NOₓ) with a reductant. In particular, SCR refers to reduction reactions wherein NOₓ is transformed to a reduction product thereof, which is preferably N₂. The term “reductant” or “reducing agent” refers to any suitable reducing agent for SCR, and may preferably include ammonia, or an ammonia precursor such as urea and/or ammonium carbamate. The reductant may refer to ammonia or may refer to hydrocarbons and/or hydrocarbon derivatives such as oxygenated hydrocarbons such as for example those which may be found in motor vehicle fuels and/or in motor vehicle exhaust gas, such as diesel fuel and/or diesel exhaust gas.

The zeolites described herein are understood to be aluminosilicates with open 3-dimensional framework structures composed of corner-sharing TO₄ tetrahedra, where T is Al or Si. Cations that balance the charge of the anionic framework are associated with the framework oxygens and the non-framework cations are general exchangeable.

The zeolites described herein generally include silica (SiO₂) and alumina (Al₂O₃) in a molar ratio that is referred to as the “silica to alumina ratio,” which may be abbreviated as “SAR.”

As used herein, zeolites may be referred to as “small-pore zeolites,” “medium-pore zeolites,” or “large-pore zeolites.” A small-pore zeolite is a zeolite whose largest pore opening is defined by a macrocycle containing eight tetrahedral metal or metalloid atoms, also referred to as an 8-ring zeolite. A medium-pore zeolite is a zeolite whose largest pore opening is defined by a macrocycle containing ten tetrahedral metal or metalloid atoms, also referred to as a 10-ring zeolite. A large-pore zeolite is a zeolite whose largest pore opening is defined by a macrocycle containing twelve or more tetrahedral metal or metalloid atoms, also referred to as a 12-ring zeolite.

As used herein, the ratio Z/r refers to the electronic charge on the metal ion divided by its ionic radius. The charge is given in units of the elementary electron charge. For example, Z=1 for Na¹⁺ and Z=2 for Mg²⁺. The ionic radius is given in units of angstrom and assumes a coordination number (CN)=6. The values for ionic radius as used herein were taken from R. D. Shannon, “Revised Effective Ionic Radii and Systematic Studies of Interatomic Distances in Halides and Chalcogenides”, Acta Cryst. A32 751-767 (1976). Such a ratio may be referred to as “the charge to radius ratio” or “the charge-to-radius ratio.” As an example, the Cu²⁺ ion has Z=2 and ionic radius=0.87 angstrom. The charge-to-radius ratio Z/r=2.30.

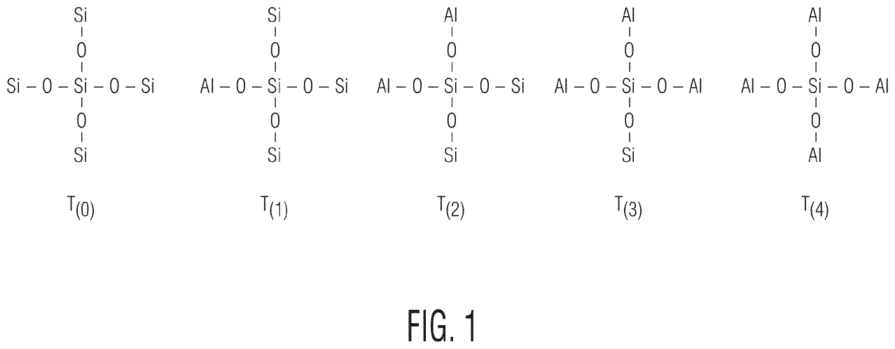

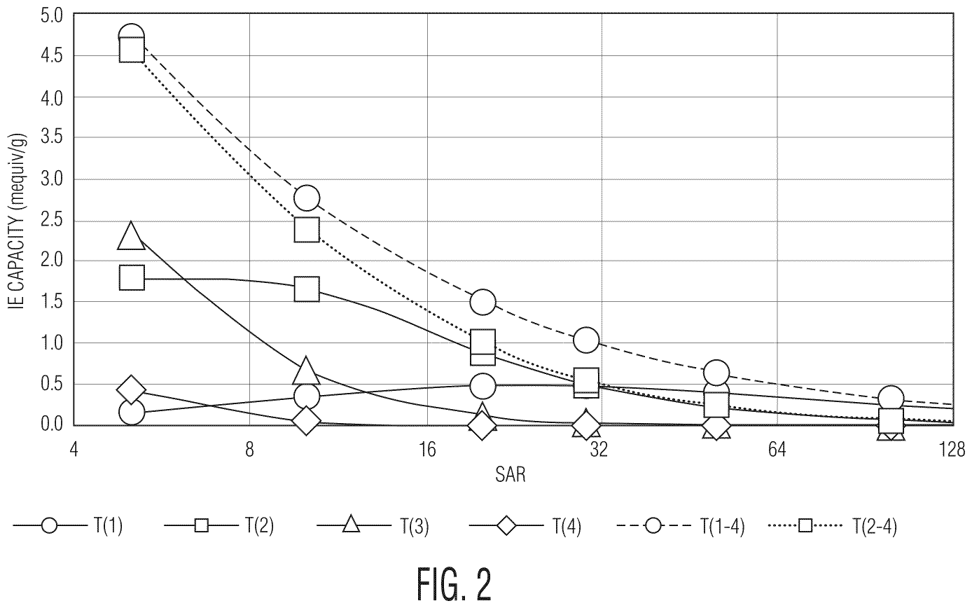

The present disclosure refers to T₍ₙ₎ sites. The tetrahedral sites in a zeolite framework are organized into different configurations labeled as T₍ₙ₎ where n is an integer between zero and 4. Each T₍ₙ₎ site is centered on a silicon atom and has n aluminum atoms in the nearest neighbor positions, as shown in FIG. 1. A randomized distribution of aluminum atoms throughout the framework is assumed, subject to Lowenstein's rule which forbids the occurrence of aluminum atoms in nearest-neighbor positions with respect to each other. Also imposed is the added restriction that where it is possible to assign an aluminum atom to more than one T₍ₙ₎ site, it will be assigned to the higher order site (i.e., the site with larger value of n). These simplifying assumptions make it possible to apply basic statistics to calculate the number of T₍ₙ₎ sites if the SAR is given. FIG. 2 shows a chart where the number of ion-exchange equivalents associated with each T₍ₙ₎ site is plotted against the zeolite SAR value subject to the assumptions and restrictions described above.

A given metal ion will preferentially interact with T₍ₙ₎ sites where its charge can be most effectively neutralized. For Cu²⁺ ions, T₍₂₎ sites will be the preferred binding sites. In general, metal ions having higher charge density will prefer to interact with framework sites of higher charge density, that is sites T₍₂₎, T₍₃₎, and T₍₄₎. The dotted line in FIG. 2 shows the sum of all ion-exchange capacity associated with sites T₍₂₋₄₎. Over most of the range of zeolite SAR, the T₍₂₎ sites are the largest contributor to the high-density ion-exchange sites. The T₍₃₎ and T₍₄₎ sites only contribute significantly at SAR less than about 10. Copper zeolite compositions where the copper loading (in ion-exchange equivalents) is lower than the number of ion-exchange equivalents associated with T₍₂₋₄₎ sites will have a fraction of uncompensated ion-exchange capacity in these sites. As copper loading is decreased, the number of “uncompensated” T₍ₙ₎ sites with n≥2 will increase. Without wishing to be bound by theory, it is believed decomposition of the zeolite framework by dealumination is faster at T₍ₙ₎ sites where n≥2 (i.e., where aluminum atoms are close together). It is further suggested that dealumination of the high-density ion-exchange sites can be suppressed if the uncompensated high-density ion-exchange sites can be compensated with suitable alternative cations.

Uncompensated ion-exchange sites in a zeolite exist as Brönsted acid sites, in which the single negative charge introduced by substitution of a single aluminum atom for a single silicon atom in the framework tetrahedral sites is balanced by a hydrogen ion. Exposure to high temperature and/or water vapor during catalyst aging can cause the substituted aluminum atom to be removed from the tetrahedral site (a process referred to as dealumination), which leads to decomposition of the zeolite framework. Substitution of hydrogen ions with copper(II) ions partially prevents the loss of aluminum atoms from the framework during aging. Without wishing to be bound by theory, it is believed that substitution of hydrogen ions with metal ions having a similar charge and ionic radius to copper(II) ions will also partially prevent the loss of aluminum atoms from the framework during aging.

As used herein, “impregnated” or “impregnation” refers to permeation of a catalytic or other material into the porous structure of a support material.

As used herein, “ion-exchange process” refers to any process which replaces part of or all the charge-compensating ions in a zeolite with different charge-compensating ions, after the zeolite has been synthesized.

As used herein, “co-exchange process” refers to an ion-exchange process which replaces part of or all the charge-compensating ions in a zeolite with a mixture of at least two different charge-compensating ions, in a single process step, after the zeolite has been synthesized.

As used herein, the term “substrate” refers to the monolithic material onto which the catalyst composition is placed, typically in the form of a washcoat containing a plurality of particles containing a catalytic composition thereon. A washcoat is formed by preparing a slurry containing a certain solid content (e.g., 30-90% by weight) of particles in a liquid suspension, which is then coated onto a substrate and dried to provide a washcoat layer.

As described herein, the term “washcoat” has its usual meaning in the art of a thin, adherent coating of a catalytic or other material applied to a substrate material from a slurry of the substance. The act of washcoating refers to the application of such a slurry to a substrate.

Aging can be conducted under various conditions and, as used herein, “aging” is understood to encompass a range of conditions (e.g., temperature, time, atmosphere). Exemplary aging protocols involve subjecting the calcined coated substrate to a temperature of 650° C. for about 50 hours in a 10% steam/air mixture or to a temperature of 750° C. for about 20 hours in a 10% steam/air mixture. However, these protocols are not intended to be limiting and the temperature can be lower or higher (for example, including but not limited to, temperatures of 400° C. and higher, for example, 400° C. to 1000° C., 600° C. to 950° C., or 650° C. to 800° C.); the time may be lesser or greater (for example, including but not limited to, times of about 1 hour to about 200 hours or about 2 hours to about 50 hours); and the atmosphere can be modified (e.g., to have different amounts of steam and/or other constituents present therein).

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine.

As used herein, the term “stream” broadly refers to any combination of flowing gas that may also contain solid or liquid particulate matter. The term “gaseous stream” or “exhaust gas stream” means a stream of gaseous constituents, such as the exhaust of a lean burn engine, which may contain entrained non-gaseous components such as liquid droplets, solid particulates, and the like. The exhaust gas stream of a lean burn engine typically further comprises combustion products, products of incomplete combustion, oxides of nitrogen, combustible and/or carbonaceous particulate matter (soot), and un-reacted oxygen and nitrogen.

In some embodiments, there is provided a catalyst composition which includes a zeolite having: a total amount of aluminum in sites T₍ₙ₎ with n≥2 of about 0.05 mequiv/g to about 5 mequiv/g, a silica to alumina ratio (SAR) of about 10 to about 100, copper, and at least one additional metal, wherein the additional metal has a charge to radius ratio (Z/r) of about 1.2 to about 3.0, and wherein the additional metal is not sodium or potassium, wherein the zeolite has a copper content between about 0.05 mequiv/g and about 5.0 mequiv/g on a Cu²⁺ basis, and wherein the copper loading in mequiv/g on a Cu²⁺ basis is less than the total amount of aluminum in sites T₍ₙ₎ with n≥2, and wherein the loading of the additional metal is chosen such that the total metal loading in mequiv/g is less than or equal to the total amount of aluminum in sites T₍ₙ₎ with n≥2.

The catalyst compositions described herein are generally metal-promoted; that is, zeolites which have one or more components intentionally added, as opposed to containing impurities which may be inherent to the zeolite. A promoter generally is a component that is intentionally added to enhance the activity of a catalyst relative to a catalyst which does not include a promoter. The presently disclosed catalyst compositions include suitable metals exchanged into zeolites in order to promote the SCR of nitrogen oxides. The catalyst compositions of the present disclosure include copper, which participates in the conversion of nitrogen oxides.

In some embodiments, the total amount of aluminum in the catalyst composition is about 0.05 mequiv/g to about 5 mequiv/g, such as about 0.05 mequiv/g, about 0.1 mequiv/g, about 0.15 mequiv/g, about 0.2 mequiv/g, about 0.3 mequiv/g, about 0.4 mequiv/g, about 0.5 mequiv/g, about 0.6 mequiv/g, about 0.7 mequiv/g, about 0.8 mequiv/g, about 0.9 mequiv/g, about 1 mequiv/g, about 1.5 mequiv/g, about 2 mequiv/g, about 2.5 mequiv/g, about 3 mequiv/g, about 3.5 mequiv/g, about 4 mequiv/g, about 4.5 mequiv/g, about 5 mequiv/g, or any range or value contained within any of the preceding values.

In some embodiments, the SAR of the catalyst composition is about 5 to about 100, such as about 5, about 10, about 15, about 20, about 25, about 30, about 35, about 40, about 45, about 50, about 55, about 60, about 65, about 70, about 75, about 80, about 85, about 90, about 95, about 100, or any range or value contained within any of the preceding values.

In some embodiments, the copper content of the catalyst composition is about 0.05 mequiv/g to about 5 mequiv/g, such as about 0.05 mequiv/g, about 0.1 mequiv/g, about 0.15 mequiv/g, about 0.2 mequiv/g, about 0.3 mequiv/g, about 0.4 mequiv/g, about 0.5 mequiv/g, about 0.6 mequiv/g, about 0.7 mequiv/g, about 0.8 mequiv/g, about 0.9 mequiv/g, about 1 mequiv/g, about 1.5 mequiv/g, about 2 mequiv/g, about 2.5 mequiv/g, about 3 mequiv/g, about 3.5 mequiv/g, about 4 mequiv/g, about 4.5 mequiv/g, about 5 mequiv/g, or any range or value contained within any of the preceding values

In some embodiments, the additional metal includes magnesium, calcium, strontium, barium, chromium, manganese, iron, cobalt, nickel, zinc, or combinations thereof. The additional metal has, in some embodiments, a charge to radius ratio (Z/r) of about 1.2 to about 3.0, such as about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, or any range or value contained within any of the preceding values. In some embodiments, the total metal loading refers to the total amount of metal, such as copper and additional metal, which are included in the catalyst composition described herein.

In some embodiments, the zeolite is a small-pore zeolite, a medium-pore zeolite, or a large-pore zeolite. The framework of the zeolite is not particularly limited, such that 8-ring zeolites, 10-ring zeolites, and 12-ring zeolites are within the scope of this disclosure. The zeolite may have a framework selected from AEI, AFT, CHA, LTA, AFX, MFI, MWW, FER, FAU, BEA, ERI, UFI, KFI, AFV, AVL, SFW, SWY, MSE, YFI, and the like, or intergrowths comprising one of these frameworks as an end-member. In some embodiments, the zeolite is CHA.

In some embodiments, the catalyst composition is coated onto a monolithic substrate in a washcoat layer. The substrate is not particularly limited, and exemplary substrates include but are not limited to metals and metal alloys such as titanium and stainless steel, alloys which includes manganese, copper, vanadium, titanium, and the like, ceramic materials such as cordierite, mullite, cordierite-α alumina, silicon nitride, zircon mullite, spodumene, alumina-silica-magnesia, zircon silicate, magnesium silicate, zircon, petalite, a alumina, aluminosilicates, and the like. In some embodiments, the substrate is a metallic, cordierite, or silicon carbide (SiC) substrate.

The substrate may be a flow-through substrate or a wall-flow substrate. A flow-through substrate may include a plurality of fine, parallel gas flow passages extending from an inlet to an outlet face of the substrate such that the passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which can be of any suitable cross-sectional shape, such as trapezoidal, rectangular, square, sinusoidal, hexagonal, oval, circular, and the like. Such structures may contain from about 60 to about 1200 or more gas inlet openings (that is, “cells”) per square inch of cross section (cpsi), more usually from about 300 to 600 cpsi. The wall thickness of flow-through substrates can vary, with a typical range being between 0.002 and 0.1 inches.

In some embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches.

In describing the quantity of washcoat or catalytic metal components or other components of the composition, it is convenient to use units of weight of component per unit volume of catalyst substrate. Therefore, the units, grams per cubic inch (“g/in³”) and grams per cubic foot (“g/ft³”), are used herein to mean the weight of a component per volume of the substrate, including the volume of void spaces of the substrate. Other units of weight per volume such as g/L are also sometimes used. The total loading of the catalytic article (i.e., both ion-exchanged metals on zeolite support material) on the catalyst substrate, such as a monolithic flow-through substrate, is typically from about 0.1 g/in³ to about 5 g/in³. It is noted that these weights per unit volume are typically calculated by weighing the catalyst substrate before and after treatment with the catalyst washcoat composition, and since the treatment process involves drying and calcining the catalyst substrate at high temperature, these weights represent an essentially solvent-free catalyst coating as essentially all of the water of the washcoat slurry has been removed. In some embodiments, the washcoat layer includes about 0.1 g/in³ to about 5.0 g/in³ of the catalyst composition, based on the bulk volume of the substrate. For example, the washcoat layer may include about 0.1 g/in³, about 0.2 g/in³, about 0.3 g/in³, about 0.4 g/in³, about 0.5 g/in³, about 1.0 g/in³, about 1.5 g/in³, about 2.0 g/in³, about 2.5 g/in³, about 3.0 g/in³, about 3.5 g/in³, about 4.0 g/in³, about 4.5 g/in³, or about 5.0 g/in³ of catalyst composition, or any range or value contained within any of the preceding values.

The catalyst compositions described herein can, in some embodiments, exhibit good SCR activity. Without wishing to be bound by theory, it is believed that the enhanced SCR activated achieved by the disclosed catalyst compositions may, in some embodiments, be due to improved hydrothermal stability of the zeolite component. Catalyst compositions which include a metal-promoted zeolite typically undergo significant deactivation upon aging (such as at a temperature of about 800° C. for a time of about 16 hours) and thus exhibit low NOₓ conversion after aging. Surprisingly, catalyst composition as disclosed herein have been found to maintain high activity (i.e., NOₓ conversion) under such aging conditions. This high activity has, in fact, been demonstrated in use at both high and low temperatures, that is, across the entire testing window of 200° C. to 600° C.

In certain embodiments, the disclosed catalyst compositions further advantageously exhibit reduced N₂O formation without a significant reduction in NOₓ conversion performance. Without wishing to be bound by theory, it is contemplated that the presence of an additional metal in a copper zeolite results in improved NO conversion coupled with lower N₂O formation, relative to zeolites which do not include an additional metal.

In some embodiments, the catalyst composition of the present disclosure is used for SCR. In some embodiments, the catalyst composition gives a conversion of NOₓ of at least about 80% at a space velocity of 60,000 h⁻¹ and a temperature greater than 250° C., after aging at a temperature greater than or equal to 550° C. Using the catalyst composition for selective catalytic reduction as described herein results, in some embodiments, in the conversion of less than about 3%, less than about 2.5%, less than about 2%, less than about 1.5%, less than about 1.0% of NO to N₂O at a temperature less than 400° C. when the NO₂/NOₓ ratio in the feed gas is about 0. In some embodiments, the catalyst composition gives a conversion of NOₓ of at least about 80%, such as at least about 85%, at least about 90%, at least about 95%, or about 100%, or any range or value contained therein, at a space velocity of 60,000 h⁻¹ and a temperature greater than 250° C., after aging at a temperature greater than or equal to 550° C. In some embodiments, using the catalyst composition of the present disclosure results in the conversion of less than about 1.0% NO to N₂O, such as less than about 1%, less than about 0.5%, less than about 0.4%, less than about 0.3%, less than about 0.2%, less than about 0.1%, or about 0.0%, at a temperature less than 400° C., when the NO₂/NOₓ ratio in the feed gas is about 0.

The catalyst compositions of the present disclosure may be characterized by analytical tools and methods familiar to those of ordinary skill in the art. The inclusion of additional metals into a zeolite, as described herein, may affect these or other properties, without wishing to be bound by theory. The stabilizing impact of these additional metals on the materials may be studied by analytical tools such as X-ray diffraction (XRD), N₂ adsorption/desorption, infrared (IR) spectroscopy and nuclear magnetic resonance (NMR) on materials before and after hydrothermal aging. An example of such an analytical tool is XRD. Without wishing to be bound by theory, it is expected that the unit cell size will expand upon introduction of additional ions in the unit cell, which can be determined from the position of peaks in the X-ray diffraction pattern. Another example of such an analytical tool is IR spectroscopy. Without wishing to be bound by theory, it is expected that the T-O-T bond vibration seen in the IR spectrum will be perturbed to different extents by the presence of different cations close to these bonds, from which an impact on the nature of copper sites may be further inferred. Analytical tools, including but not limited to XRD and IR spectroscopy, may be employed to study the effects of the presence or absence of additional metals as described herein.

There is provided herein a method for decreasing the amount of NOₓ in a gas stream which contains NOₓ including contacting the gas stream with a catalyst composition including a zeolite having: a total amount of aluminum in sites T₍ₙ₎ with n≥2 of about 0.05 mequiv/g to about 5 mequiv/g, a silica to alumina ratio (SAR) of about 5 to about 120, copper, and at least one additional metal, wherein the additional metal has a charge to radius ratio (Z/r) of about 1.2 to about 3.0, and wherein the additional metal is not sodium or potassium, wherein the zeolite has a copper content between about 0.05 mequiv/g and about 5.0 mequiv/g on a Cu²⁺ basis, and wherein the copper loading in mequiv/g on a Cu²⁺ basis is less than the total number of aluminum in sites T₍ₙ₎ with n≥2, and wherein the loading of the additional metal is chosen such that the total metal loading in mequiv/g is less than or equal to the total number of aluminum in sites T₍ₙ₎ with n≥2.

In some embodiments, the method for decreasing the amount of NOₓ in a gas stream which contains NOₓ includes contacting the gas stream with a catalyst composition according to any of the embodiments or combinations of embodiments as described herein.

There is provided an exhaust gas treatment system which includes an NOₓ generator which produces an exhaust gas stream containing NOₓ, a catalyst composition which includes a zeolite having: a total amount of aluminum in sites T₍ₙ₎ with n≥2 of about 0.05 mequiv/g to about 5 mequiv/g, a silica to alumina ratio (SAR) of about 5 to about 120, copper, and at least one additional metal, wherein the copper content is between about 0.05 mequiv/g and about 5.0 mequiv/g on a Cu²⁺ basis, and the additional metal has a charge to radius ratio (Z/r) of about 1.2 to about 3.0, and wherein the additional metal is not sodium or potassium, and wherein the copper loading in mequiv/g on a Cu²⁺ basis is less than the total number of aluminum in sites T₍ₙ₎ with n≥2, and wherein the loading of the additional metal is chosen such that the total metal loading in mequiv/g is less than or equal to the total number of aluminum in sites T₍ₙ₎ with n≥2. The exhaust gas treatment system further includes an injector configured to inject a reducing agent into the gas stream. In some embodiments, the NOₓ generator is an internal combustion engine, an external combustion engine, or a chemical reactor.

In some embodiments, the catalyst composition is in fluid communication with an exhaust gas stream, and the reducing agent and the catalyst composition promote the conversion of NOₓ to a composition which includes N₂ and water. In some embodiments, the exhaust gas treatment system includes a catalyst composition according to any of the embodiments or combinations of embodiments as described herein. In some embodiments, the exhaust gas treatment system includes a second catalyst composition, which may be a catalyst composition as described herein, such as a catalyst for SCR, or any other catalyst composition known to those skilled in the art. In some embodiments, the catalyst composition is in a close-coupled position, wherein the catalyst composition is positioned directly at the exhaust outlet of the engine. In some embodiments, there is no catalytic exhaust system component positioned upstream of the catalyst composition. In other embodiments, there are one or more catalytic exhaust system components positioned upstream of the catalyst composition. In some embodiments, there are one or more catalytic exhaust system components positioned downstream of the catalyst composition.

The embodiments described herein may be combined in any fashion to form new embodiments. It is contemplated that the catalyst compositions, methods, and exhaust gas treatment systems described herein may, in some embodiments, be used together. For example, the catalyst composition as disclosed herein may, when used in an exhaust gas treatment system as disclosed herein, give a conversion of NOₓ of at least 85% at a space velocity of 60,000 h⁻¹ and a temperature greater than 250° C., after aging at a temperature greater than or equal to 550° C., and result in the conversion of less than 1.0% of NO to N₂O at a temperature less than 400° C. when the catalyst composition is used for selective catalytic reduction.

### EXAMPLES

The following examples were carried out in accordance with embodiments as described herein. Example compositions are described in TABLE 1.

### Example 1: Copper Exchange CHA Zeolite

Chabazite zeolite with SAR=16 was pre-calcined at 600° C. for 1 hr. The calcined zeolite was impregnated with an aqueous solution of copper acetate in a copper/zeolite ratio=0.25 mmol/g by incipient wetness impregnation. The impregnated zeolite powder was allowed to stand for 24 h in a closed container at 50° C. Then the powder was dried at 100° C. followed by calcination at 600° C. for 1 hr in air to produce powder B1.

### Example 2: Copper-Exchanged CHA Zeolite with Additional Magnesium or Zinc Prepared By Sequential Impregnation

A copper-exchanged zeolite powder with copper loading=0.25 mmol/g was prepared as described in Example 1. This copper-exchanged zeolite was impregnated with an aqueous solution of magnesium acetate in a magnesium/zeolite ratio=0.15 mmol/g by incipient wetness impregnation. The impregnated zeolite powder was allowed to stand for 24 hr in a closed container at 50° C. Then the powder was dried at 100° C. followed by calcination at 600° C. for 1 hr in air to give powder C2. The preparation was repeated with a magnesium/zeolite ratio=0.30 mmol/g to give powder D2. The preparation was repeated with a magnesium/zeolite ratio=0.45 mmol/g to give powder E2.

A copper-exchanged zeolite powder with copper loading=0.25 mmol/g was prepared as described in Example 1. This copper-exchange zeolite was impregnated with an aqueous solution of zinc acetate in a zinc/zeolite ratio=0.15 mmol/g by incipient wetness impregnation. The impregnated zeolite powder was allowed to stand for 24 h in a closed container at 50° C. Then the powder was dried at 100° C. followed by calcination at 600° C. for 1 hr in air to give powder F2. The preparation was repeated with zinc/zeolite ratio=0.30 mmol/g to give powder G2. The preparation was repeated with a zinc/zeolite ratio=0.45 mmol/g to give powder H2.

### Example 3: Copper-Exchanged CHA Zeolite with Additional Magnesium or Zinc Prepared By Sequential Impregnation

Chabazite zeolite with SAR=16 was impregnated with an aqueous solution of magnesium acetate in a magnesium/zeolite ratio=0.15 mmol/g by incipient wetness impregnation. The impregnated zeolite powder was allowed to stand for 24 hr in a closed container at 50° C. Then the powder was dried at 100° C. followed by calcination at 600° C. for 1 hr in air. The magnesium-exchanged zeolite was impregnated with an aqueous solution of copper acetate in a copper/zeolite ratio=0.25 mmol/g by incipient wetness impregnation. The impregnated zeolite powder was allowed to stand for 24 hr in a closed container at 50° C. Then the powder was dried at 100° C. followed by calcination at 600° C. for 1 hr in air to give powder C3. The preparation was repeated with magnesium/zeolite ratio=0.30 mmol/g to give powder D3. The preparation was repeated with a magnesium/zeolite ratio=0.45 mmol/g to give powder E3.

Chabazite zeolite with SAR=16 was impregnated with an aqueous solution of zinc acetate in a zinc/zeolite ratio=0.15 mmol/g by incipient wetness impregnation. The impregnated zeolite powder was allowed to stand for 24 hr in a closed container at 50° C. Then the powder was dried at 100° C. followed by calcination at 600° C. for 1 hr in air. The zinc-exchanged zeolite was impregnated with an aqueous solution of copper acetate in a copper/zeolite ratio=0.25 mmol/g by incipient wetness impregnation. The impregnated zeolite powder was allowed to stand for 24 hr in a closed container at 50° C. Then the powder was dried at 100° C. followed by calcination at 600° C. for 1 hr in air to give powder F3. The preparation was repeated with a zinc/zeolite ratio=0.30 mmol/g to give powder G3. The preparation was repeated with a zinc/zeolite ratio=0.45 mmol/g to give powder H3.

### Example 4: Copper-Exchanged CHA Zeolite with Additional Magnesium or Zinc Prepared By Co-Impregnation

Chabazite zeolite with SAR=16 was precalcined at 600° C. for 1 hr. The calcined zeolite was impregnated with an aqueous solution containing copper acetate (copper/zeolite ratio=0.25 mmol/g) and magnesium acetate (magnesium/zeolite ratio=0.15 mmol/g) by incipient wetness impregnation. The impregnated zeolite powder was allowed to stand for 24 hr in a closed container at 50° C. Then the powder was dried at 100° C. followed by calcination at 600° C. for 1 hr in air to give powder C4. The preparation was repeated with a magnesium/zeolite ratio=0.30 mmol/g to give powder D4. The preparation was repeated with a magnesium/zeolite ratio=0.45 mmol/g to give powder E4.

Chabazite zeolite with SAR=16 was precalcined at 600° C. for 1 hr. The calcined zeolite was impregnated with an aqueous solution containing copper acetate (copper/zeolite ratio=0.25 mmol/g) and zinc acetate (zinc/zeolite ratio=0.15 mmol/g) by incipient wetness impregnation. The impregnated zeolite powder was allowed to stand for 24 hr in a closed container at 50° C. Then the powder was dried at 100° C. followed by calcination at 600° C. for 1 hr in air to give powder F4. The preparation was repeated with a zinc/zeolite ratio=0.30 mmol/g to give powder G4. The preparation was repeated with a zinc/zeolite weight ratio=0.45 mmol/g to give powder H4.

### Example 5: Evaluation of Powders for SCR Activity after Aging at 550° C.

Each zeolite powder was suspended in deionized water at a concentration of 30% by weight (solids basis). Zirconium acetate was added to give 5 wt. % zirconium (ZrO₂ basis) relative to the zeolite solids. The suspension was homogenized and dried under stirring to yield pellets. The pellets were calcined at 500° C. for 1 h. The calcined pellets were crushed and sieved to size range between 250-500 μm. The sieved fraction was aged at 550° C. for 50 h in a 10% steam/air atmosphere. 120 mg of the aged material was diluted with corundum to give a total packed volume=1.0 cm³, and this material was packed into a cylindrical microreactor. The microreactor was fed with a stream consisting of 500 ppm NO, 500 ppm NH₃, 5% H₂O, 10% O₂, and balance N₂ at a flow rate=1333 cm³/min. The amount of NO, NO₂, NH₃, and N₂O in the effluent gas was monitored by FTIR spectroscopy at T=175, 200, 225, 250, 300, 400, 550, and 575° C.

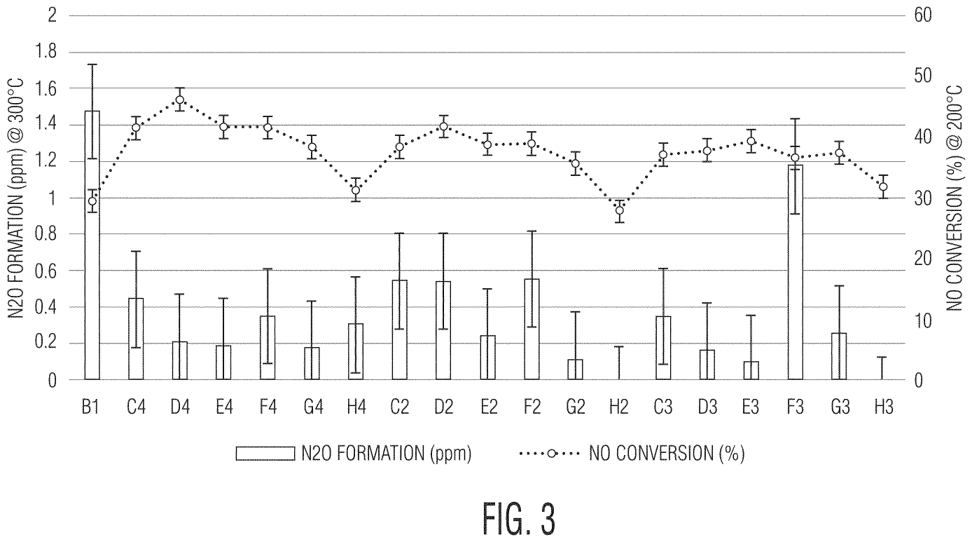

TABLE 1 describes each zeolite formulation evaluated for SCR activity. Under the conditions applied for evaluation of the SCR activity, the maximum in N₂O formation was observed at T=300° C. The bars in FIG. 3 show the concentration of N₂O measured at T=300° C. at the reactor outlet. The significant result is that all the zeolite formulations containing magnesium or zinc (C2-H4) give lower N₂O formation than the copper-only control sample B1 at the common copper loading (0.25 mmol/g). The average decrease in N₂O formed is 79% relative to the amount of N₂O produced by the control sample B1. It is well understood that the amount of N₂O formed by an SCR catalyst can be decreased by measures that decrease the overall conversion of NOₓ, which presents an undesired tradeoff between activity and selectivity. It is therefore significant that all the zeolite formulations A1-H4 give NO conversion at 300° C. greater than 96% so that the same amount of NO is being converted in every case. This indicates that the lower N₂O formation for the formulations containing magnesium and zinc cannot be accounted for based on conversion of less NO. The dotted line in FIG. 3 shows the trend in NO conversion at 200° C. At this temperature we are operating at less than 50% NO conversion under the test conditions specified, and we can differentiate the formulations based on NO conversion activity. The data show that all the zeolite formulations containing magnesium or zinc (C2-H4) give equivalent or higher NO conversion activity relative to the copper-only control sample B1. By addition of certain additional metals (e.g. magnesium and/or zinc to the copper-zeolite formulation, we have simultaneously achieved an increase in NO conversion activity and a decrease in N₂O formation activity after a model accelerated aging procedure.

### Example 6: Evaluation of Powders for SCR Activity after Aging at 650° C.

A subset of the sieved powders was aged at 650° C. for 50 hr in a 10% steam/air atmosphere. 120 mg of the aged material was diluted with corundum to give a total packed volume=1.0 cm³, and this material was packed into a cylindrical microreactor. The microreactor was fed with a stream consisting of 500 ppm NO, 500 ppm NH₃, 5% H₂O, 10% O₂, and balance N₂ at a flow rate=1333 cm³/min. The amount of NO, NO₂, NH₃, and N₂O in the effluent gas was monitored by FTIR spectroscopy at T=175, 200, 225, 250, 300, 400, 550, and 575° C.

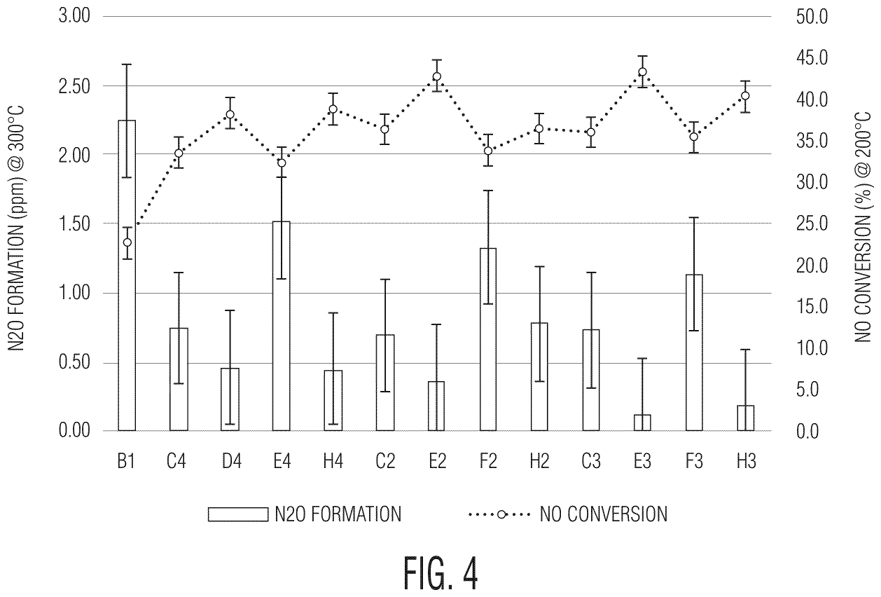

The bars in FIG. 4 show the concentration of N₂O measured at T=300° C. at the reactor outlet. After the aging procedure at 650° C., all the zeolite formulations containing magnesium or zinc (C2-H4) give lower N₂O formation than the copper-only control sample B1 at the common copper loading (0.25 mmol/g). The average decrease in N₂O formed is 70% relative to the amount of N₂O produced by the control sample B1. These data show that the positive effect of the cocation on the formation of N₂O persists after a more severe aging protocol. At the same time, the dotted line in FIG. 4 shows that the NO conversion at 200° C. is increased by 64% on average for the magnesium-containing and zinc-containing formulations relative to the copper-only control sample B1. The average NO conversion for the formulations containing the additional metal is 38% after aging at 550° C. and 37% after aging at 650° C. For comparison the NO conversion of the copper-only control formulation is 29% after aging at 550° C. and 22% after aging at 650° C. As a result, the improvement in NO conversion for the formulations containing the cocation becomes more pronounced after the more severe aging. These data indicate that addition of the cocation has the effect of increasing the stability of the material against hydrothermal aging.

### Example 7: Effect of Magnesium Loading

Chabazite zeolite with SAR=16 was precalcined at 600° C. for 1 hr. The calcined zeolite was co-impregnated with an aqueous solution containing in a copper/zeolite ratio=0.25 mmol/g plus a variable amount of magnesium acetate, by incipient wetness impregnation. The impregnated zeolite powder was allowed to stand for 24 h in a closed container at 50° C. Then the powder was dried at 100° C. followed by calcination at 600° C. for 1 hr in air. The resulting powders contained 0.25 mmol/g copper and a variable amount of magnesium. The formulations are described in TABLE 2 (C4-L4). The powders were hydrothermally aged at 550° C., 50 hr, 10% H₂O/air and evaluated in a steady-state SCR test as described in Example 6.

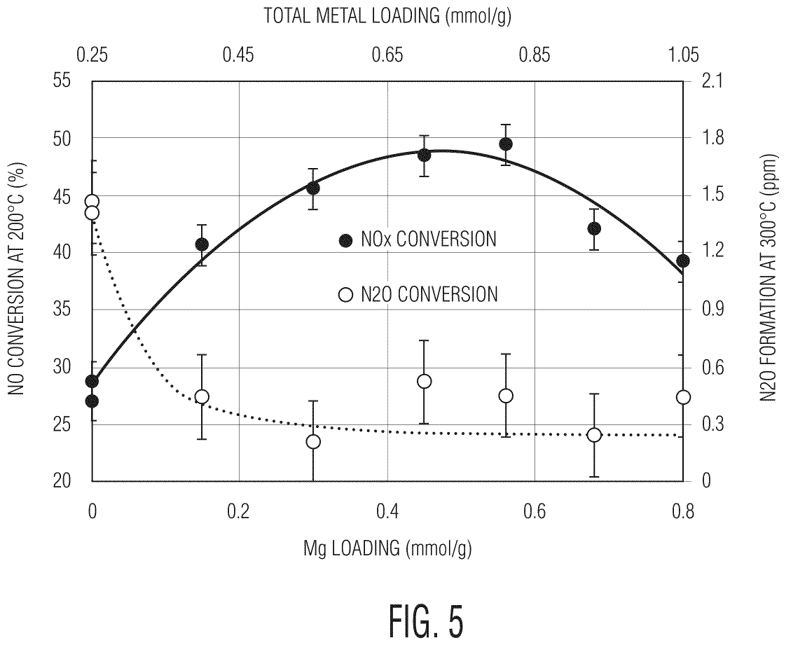

FIG. 5 shows that NOₓ conversion at 200° C. passes through a maximum as magnesium loading is increased, with the maximum conversion occurring at magnesium loading=0.48 mmol/g. The combined copper+magnesium loading at this point is 0.71 mmol/g, which is very close to the value estimated to occupy all paired aluminum sites when SAR=16. When magnesium loading is further increased, a fraction of the copper ions is displaced from the optimal T₍₂₎ sites which results in a decrease in the NOₓ conversion activity. FIG. 5 shows that N₂O formation at 300° C. decreases sharply as magnesium loading is increased up to 0.30 mmol/g. There is no significant change in N₂O formation when magnesium loading is increased further. Therefore, when SAR=16 and copper loading=0.25 mmol/g, the optimal performance for high NOₓ conversion and low N₂O formation is found when the magnesium loading is between 0.4 mmol/g and 0.5 mmol/g.

### Example 8: Effect of Zinc Loading

Chabazite zeolite with SAR=16 was precalcined at 600° C. for 1 hr. The calcined zeolite was co-impregnated with an aqueous solution containing copper acetate in a copper/zeolite ratio=0.25 mmol/g plus a variable amount of zinc acetate, by incipient wetness impregnation. The impregnated zeolite powder was allowed to stand for 24 h in a closed container at 50° C. Then the powder was dried at 100° C. followed by calcination at 600° C. for 1 hr in air. The resulting powder contained 0.25 mmol/g copper and a variable amount of zinc. The formulations are described in TABLE 2 (F4-P4). The powders were hydrothermally aged at 550° C., 50 hr, 10% H₂O/air and evaluated in a steady-state SCR test as described in Example 6.

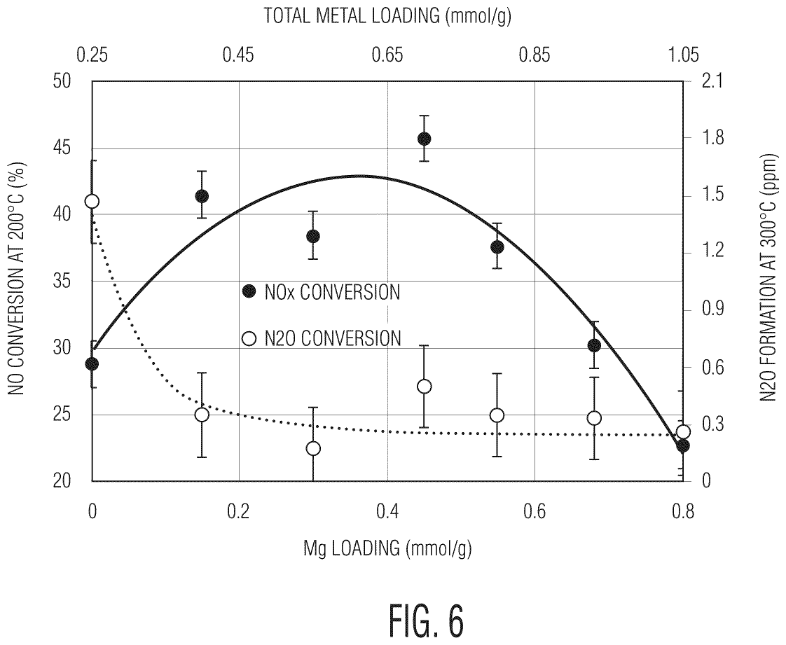

FIG. 6 shows that NOₓ conversion at 200° C. passes through a maximum as zinc loading is increased, with the maximum conversion occurring at zinc loading=0.45 mmol/g. The combined copper+zinc loading at this point is 0.71 mmol/g, which is very close to the value estimated to occupy all paired aluminum sites when SAR=16. When zinc loading is further increased, a fraction of the copper ions is displaced from the optimal T₍₂₎ sites which results in a decrease in the NOₓ conversion activity. FIG. 6 shows that N₂O formation at 300° C. decreases sharply as zinc loading is increased up to 0.30 mmol/g. There is no significant change in N₂O formation when magnesium loading is increased further. Therefore, when SAR=16 and copper loading=0.25 mmol/g, the optimal performance for high NOₓ conversion and low N₂O formation is found when the zinc loading is between 0.4 mmol/g and 0.5 mmol/g. The similarity in the trend for magnesium loading and zinc loading in FIGS. 5 and 6 indicates that zinc and magnesium ions have a common role in stabilizing the zeolite structure and suppressing N₂O formation.

### Example 9: Preparation and Evaluation of Monolith Samples with Zeolite Copper Loading=0.25 mmol/g

A CHA zeolite having SAR=16 or SAR=10 was pre-calcined at 550° C. to generate the proton form. The calcined zeolite powder was impregnated with a solution containing copper acetate and magnesium acetate or zinc acetate. The copper/zeolite ratio was fixed at a value of 0.25 mmol/g. The amount of magnesium or zinc used depended on the zeolite SAR as described in TABLE 3. After impregnation, the wet powder was allowed to soak at 25° C. for 24 hr in a sealed jar and then it was dried and calcined at 550° C. The resulting zeolite powders were suspended in DI water and milled to a D₉₀ particle size <9 μm. The resulting slurry was applied to 1″ OD×3″ L ceramic monoliths with a channel density=400/in², and the coated monoliths were dried and calcined at 550° C. for 1 hr. The sample formulations are described in TABLE 3. Samples of each formulation were degreened at 550° C. for 4 hr in 10% H₂O/air, aged at 550° C. for 200 hr in 10% H₂O/air, aged at 650° C. for 50 h in 10% H₂O/air, or aged at 750° C. for 20 hr in 10% H₂O/air.

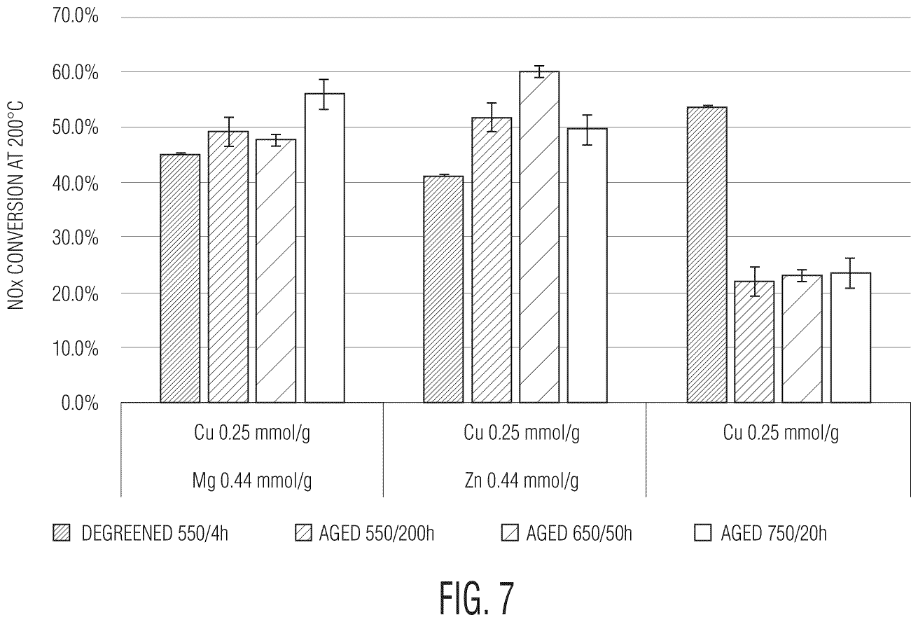

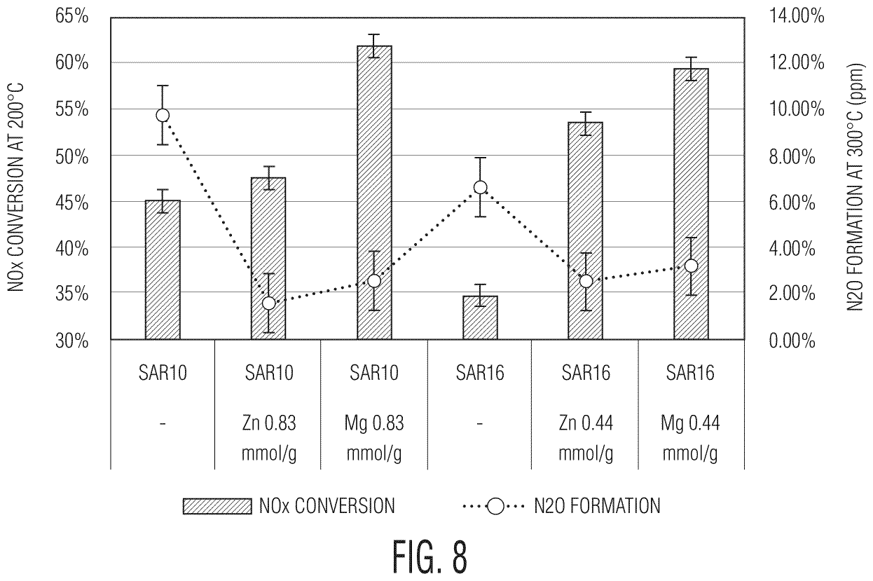

The degreened and aged samples were evaluated for SCR activity using a standard SCR protocol: 1000 ppm NH₃, 1000 ppm NO, 8% CO₂, 7% H₂O, 10% O₂, balance N₂, SV=60,000/hr. FIG. 7 shows the NOₓ conversion for formulations with SAR=16 and containing 0.25 mmol/g copper and 0.44 mmol/g magnesium or zinc in the degreened state and after aging at successively higher temperatures. The formulations containing magnesium or zinc show no advantage in NOₓ after degreening. After aging the formulations containing magnesium or zinc show at least 2-fold higher NOₓ conversion at 200° C. relative to the formulation containing only copper. This is due to the large decrease in NOₓ conversion for the copper-only formulation upon aging, which is not seen for the formulations also containing magnesium or zinc. This data shows how the additional magnesium or zinc serves to stabilize the zeolite NOₓ conversion activity when the overall Cu/Al atom ratio is 0.13. The NOₓ conversion at 200° C. and N₂O formation at 300° C. are shown in FIG. 8 for the six catalyst formulations in TABLE 3, after aging at 650° C. for 50 hr. This chart demonstrates that the favorable effect of adding magnesium or zinc is seen with chabazite zeolite having SAR=16 or 10, but that the zeolite having SAR=10 can accommodate much higher loading of the of magnesium or zinc when copper is fixed at 0.25 mmol/g. This leads to an even larger decrease in N₂O formation at SAR=10 due to the higher loading of magnesium or zinc that is possible.

### Example 10: Preparation and Evaluation of Monolith Samples with Zeolite Copper Loading=0.12 mmol/g

A CHA zeolite having SAR=16 was pre-calcined at 550° C. to generate the proton form. The calcined zeolite powder was impregnated with a solution containing copper acetate and either magnesium acetate or zinc acetate. The copper/zeolite ratio was fixed at a value of 0.12 mmol/g. An additional amount of magnesium or zinc was combined in the impregnation solution at a level corresponding to a magnesium/zeolite ratio or a zinc/zeolite ratio of 0.57 mmol/g. This solution was used to impregnate the calcined zeolite. The resulting wet powder was allowed to soak at 25° C. for 24 hr in a sealed jar and then it was dried and calcined at 550° C. The resulting zeolite powders were suspended in DI water and milled to a D₉₀ particle size <9 μm. The resulting slurry was applied to 1″ OD×3″ L ceramic monoliths with a channel density=400/in², and the coated monoliths were dried and calcined at 550° C. for 1 hr. The sample formulations are described in TABLE 4. Samples of each formulation were aged at 650° C. for 50 h in 10% H₂O/air.

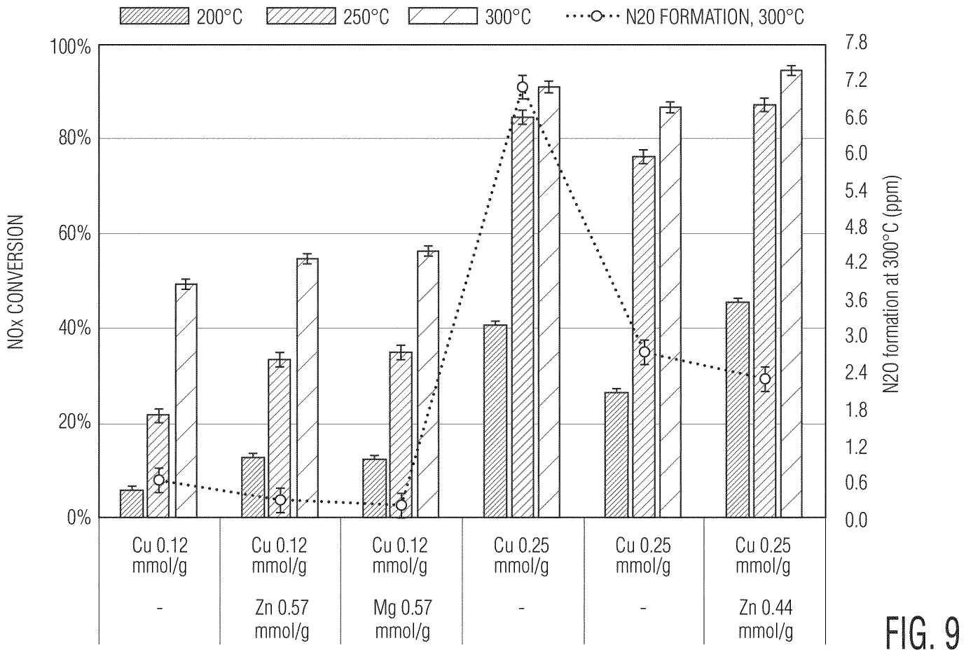

The aged samples were evaluated for SCR activity using a standard SCR protocol: 1000 ppm NH3, 1000 ppm NO, 8% CO₂, 7% H₂O, 10% O₂, balance N₂, SV=60,000/hr. FIG. 9 shows that when copper loading=0.12 mmol/g, NOₓ conversion at 250° C. and 300° C. after aging at 650° C. is increased by adding an amount of magnesium or zinc corresponding to fulfillment of the residual T₍₂₄₎ sites. N₂O formation is also decreased by adding magnesium or zinc. FIG. 9 also shows that decreasing the copper loading from 0.25 mmol/g to 0.12 mmol/g decreases N₂O formation, but it also decreases NOₓ conversion as expected. This shows how the formulation can be tuned for different applications depending on whether high NOₓ conversion or low N₂O formation is the more important requirement.

### Example 11: Evaluation of Coated Monoliths Under Different NO₂/NOₓ Feed Composition

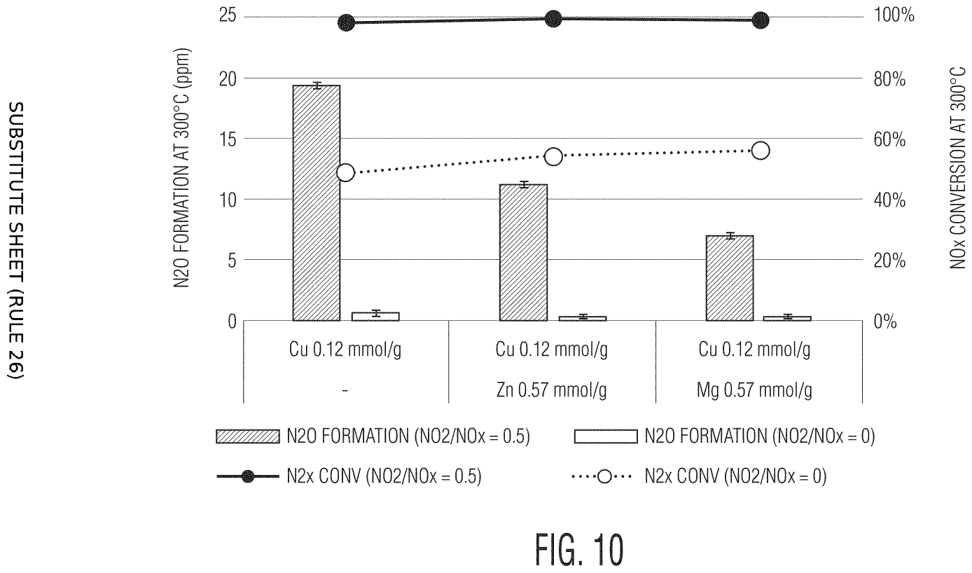

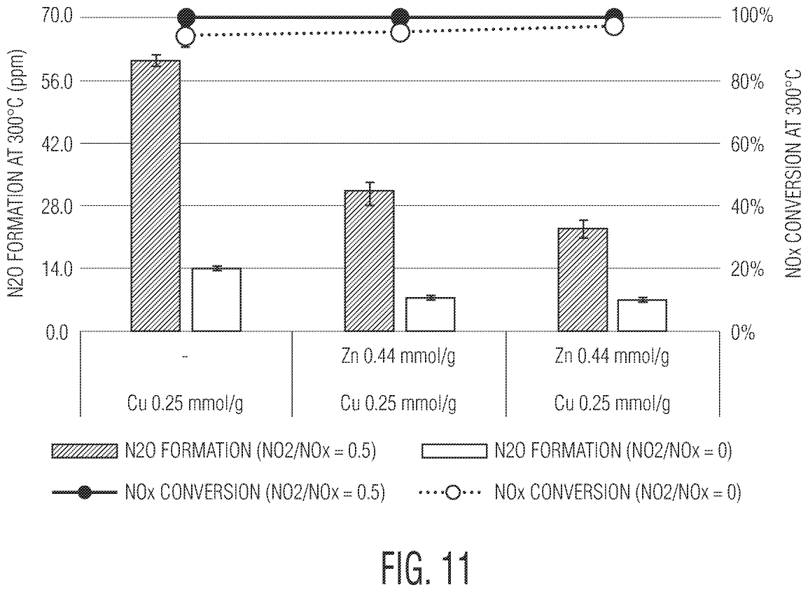

Coated monoliths were evaluated for NOₓ conversion activity under feed conditions containing a 1:1 mixture of NO and NO₂(NO₂/NOₓ=0.5): 1000 ppm NH₃, 500 ppm NO, 500 ppm NO₂, 8% CO₂, 7% H₂O, 10% O₂, balance N₂, SV=60,000/hr. FIG. 10 shows results for a CHA zeolite (SAR=16) containing 0.12 mmol/g copper and 0.57 mmol/g magnesium or zinc, after aging at 650° C. for 50 hr in 10% H₂O/air. We can observe an increase in net NOₓ conversion when the NO₂/NOₓ ratio is increased from zero to 0.5 as expected. For this reason, the feed condition containing NO₂/NOₓ=0.5 is commonly referred to as the “fast” SCR condition. FIG. 10 shows that formation of N₂O is increased when the NO₂/NOₓ ratio is increased from zero to 0.5 as expected. The formulations containing magnesium or zinc still give lower formation of N₂O than the comparable formulation without magnesium or zinc even at the higher NO₂/NOₓ ratio. FIG. 11 shows the results for a CHA zeolite (SAR=16) containing 0.25 mmol/g copper and additional 0.44 mmol/g magnesium or zinc, after aging at 650° C. for 50 hr in 10% H₂O/air. The results show that the addition of magnesium or zinc leads to a lower formation of N₂O under the “fast” SCR condition at the higher copper loading as well. Addition of exchanged magnesium or zinc to a copper-exchanged zeolite leads to a decrease in N₂O formation activity even when the feed gas contains NO₂.

### Example 12: Preparation and Evaluation of Monolith Samples with Zeolite Copper Loading 0.44 mmol/g

A CHA zeolite having SAR=16 was suspended in DI water and milled to a D₉₀ particle size <9 μm. CuO powder was added in a copper/zeolite ratio=0.44 mmol/g. The slurry was agitated for 24 hr and then applied to 1″ OD×3″ L ceramic monoliths with a channel density=400/in². The coated monoliths were dried and calcined at 550° C. for 1 hr to give sample L30 (TABLE 5). Samples were de-greened at 650° C. for 2 hr in static air or aged at 650° C. for 50 h in 10% H₂O/air. The de-greened and aged samples were evaluated for SCR activity using a standard SCR protocol: 500 ppm NH₃, 500 ppm NO, 8% CO₂, 7% H₂O, 10% O₂, balance N₂, SV=80,000/hr.

### Example 13: Preparation and Evaluation of Monolith Samples with Zeolite Copper Loading=0.44 Mmol/g and Different Loadings of Magnesium or Zinc

A CHA zeolite having SAR=16 was pre-calcined at 550° C. to generate the proton form. The calcined zeolite powder was impregnated with a solution containing copper acetate and either magnesium acetate or zinc acetate. The copper/zeolite ratio was fixed at a value of 0.44 mmol/g. For magnesium-containing samples the magnesium/zeolite ratio was 0.13 mmol/g (L31), 0.25 mmol/g (L32), or 0.48 mmol/g (L33) as described in TABLE 5. For zinc-containing samples the zinc/zeolite ratio was 0.12 mmol/g (L34) or 0.23 mmol/g (L35) as described in TABLE 5. After impregnation, the wet powder was allowed to soak at 25° C. for 24 hr in a sealed jar and then it was dried and calcined at 550° C. The resulting zeolite powders were suspended in DI water and milled to a D₉₀ particle size <9 μm. The resulting slurry was applied to 1″ OD×3″ L ceramic monoliths with a channel density=400/in², and the coated monoliths were dried and calcined at 550° C. for 1 hr. Samples of each formulation were de-greened at 650° C. for 2 hr in static air, or aged at 650° C. for 50 h in 10% H₂O/air. The de-greened and aged samples were evaluated for SCR activity using a standard SCR protocol: 500 ppm NH₃, 500 ppm NO, 8% CO₂, 7% H₂O, 10% O₂, balance N₂, SV=80,000/hr.

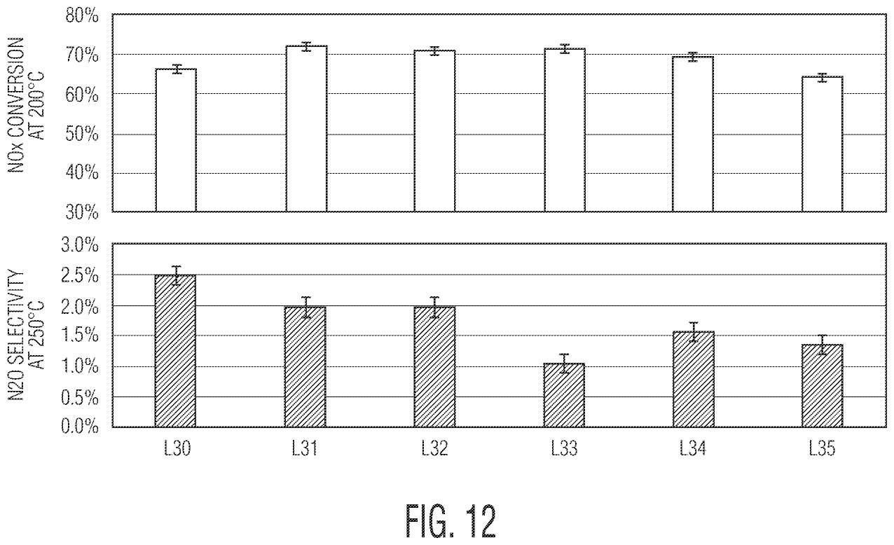

FIG. 12 shows NOₓ conversion at 200° C. for a sequence of aged catalyst formulations (650° C. for 50 h in 10% H₂O/air) having a copper loading=0.44 mmol/g and different loadings of magnesium or zinc as indicated. The data show it is possible to increase NOₓ conversion after aging by adding the additional metal species up to a total metal loading=0.69 mmol/g. FIG. 12 also shows how N₂O formation can be decreased by adding the additional metal ion. The degree of improvement is smaller than was seen for the formulations containing copper at loading of 0.25 mmol/g or 0.12 mmol/g. This is due to the fact that as copper loading is increased in a zeolite with fixed SAR, the amount of uncompensated ion-exchange capacity in sites T₍₂₄₎ is decreased. As a result, the amount of additional metal that can be accommodated in the residual T₍₂₋₄₎ sites is lower.

### Example 14: Preparation of Monolith Samples with Zeolite Copper Loading=0.63 Mmol/g

A CHA zeolite having SAR=16 were suspended in DI water and milled to a D₉₀ particle size <9 μm. CuO powder was added in a copper/zeolite ratio of 0.63 mmol/g. The resulting slurry was agitated for 24 hr and then applied to 1″ OD×3″ L ceramic monoliths with a channel density=400/in², and the coated monoliths were dried and calcined at 550° C. for 1 hr to give sample J30 (TABLE 5). Samples of each formulation were de-greened at 650° C. for 2 hr in static air, or aged at 650° C. for 50 h in 10% H₂O/air.

### Example 15: Preparation of Monolith Samples with Zeolite Copper Loading=0.63 Mmol/g And Different Loadings of Magnesium or Zinc

A CHA zeolite having SAR=16 was pre-calcined at 550° C. to generate the proton form. The calcined zeolite powder was impregnated with a solution containing copper acetate and either magnesium acetate or zinc acetate. The copper/zeolite ratio was fixed at a value of 0.63 mmol/g. For magnesium-containing samples the magnesium/zeolite ratio was 0.074 mmol/g (J32) as described in TABLE 5. For zinc-containing samples the zinc/zeolite ratio was 0.061 mmol/g (J35) as described in TABLE 5. After impregnation, the wet powder was allowed to soak at 25° C. for 24 hr in a sealed jar and then it was dried and calcined at 550° C. The resulting zeolite powders were suspended in DI water and milled to a D₉₀ particle size <9 μm. The resulting slurry was applied to 1″ OD×3″ L ceramic monoliths with a channel density=400/in², and the coated monoliths were dried and calcined at 550° C. for 1 hr. Samples of each formulation were de-greened at 650° C. for 2 hr in static air, or aged at 650° C. for 50 h in 10% H₂O/air.

### Example 16: Preparation of Monolith Samples with Zeolite Copper Loading=0.50 Mmol/g

A CHA zeolite having SAR=16 were suspended in DI water and milled to a D₉₀ particle size <9 μm. CuO powder was added in a copper/zeolite ratio of 0.50 mmol/g. The resulting slurry was agitated for 24 hr and then applied to 1″ OD×3″ L ceramic monoliths with a channel density=400/in², and the coated monoliths were dried and calcined at 550° C. for 1 hr to give sample K30 (TABLE 5). Samples of each formulation were de-greened at 650° C. for 2 hr in static air, or aged at 650° C. for 50 h in 10% H₂O/air.

### Example 17: Preparation of Monolith Samples with Zeolite Copper Loading=0.50 Mmol/g and Different Loadings of Magnesium or Zinc

A CHA zeolite having SAR=16 was pre-calcined at 550° C. to generate the proton form. The calcined zeolite powder was impregnated with a solution containing copper acetate and either magnesium acetate or zinc acetate. The copper/zeolite ratio was fixed at a value of 0.50 mmol/g. For magnesium-containing samples the magnesium/zeolite ratio was 0.19 mmol/g (K32) as described in TABLE 5. For zinc-containing samples the zinc/zeolite ratio was also 0.19 mmol/g (K35) as described in TABLE 5. After impregnation, the wet powder was allowed to soak at 25° C. for 24 hr in a sealed jar and then it was dried and calcined at 550° C. The resulting zeolite powders were suspended in DI water and milled to a D₉₀ particle size <9 μm. The resulting slurry was applied to 1″ OD×3″ L ceramic monoliths with a channel density=400/in², and the coated monoliths were dried and calcined at 550° C. for 1 hr. Samples of each formulation were de-greened at 650° C. for 2 hr in static air, or aged at 650° C. for 50 h in 10% H₂O/air.

### Example 18: Evaluation of Degreened and Aged Monolith Samples at Different Copper Loadings

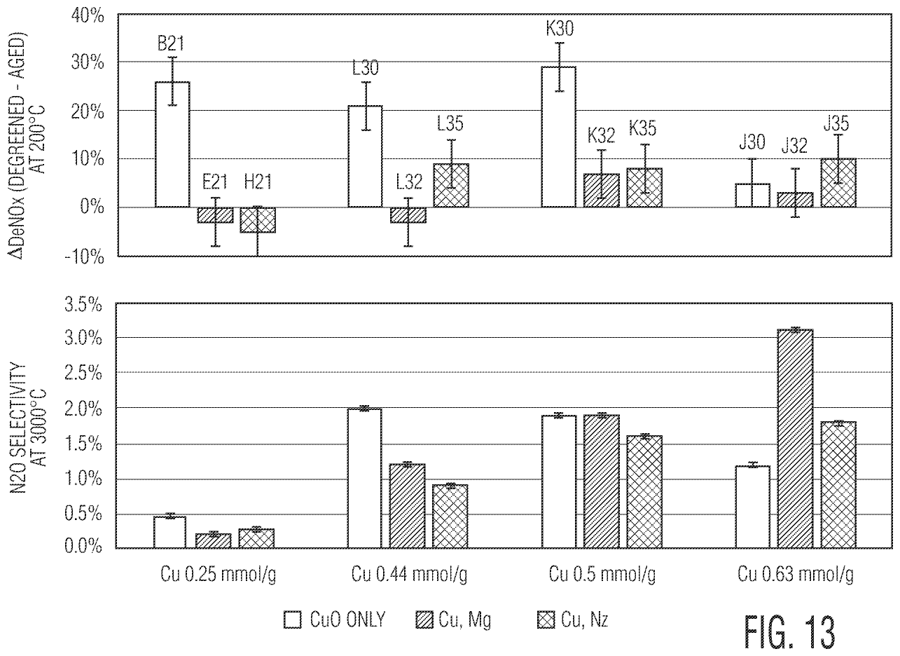

The de-greened and aged samples were evaluated for SCR activity using a standard SCR protocol: 500 ppm NH₃, 500 ppm NO, 8% CO₂, 7% H₂O, 10% 02, balance N₂, SV=80,000/hr. The top chart in FIG. 13 shows the absolute difference (ΔdeNOₓ) between the NOₓ conversion at T=200° C. for a given catalyst formulation in the degreened state and aged state. The bottom chart shows N₂O selectivity at T=300° C. for the same series of catalyst samples. Data is shown for catalyst formulations with copper loading of 0.25, 0.44, 0.50, and 0.63 mmol/g. The black bars in FIG. 13 show ΔdeNOₓ and N₂O selectivity for formulations without any additional magnesium or zinc (i.e. copper-only formulations). Decreasing copper loading to 0.25 mmol/g leads to a large decrease in the selectivity for forming N₂O from NO and NH₃ but also a value for ΔdeNOₓ=26%, indicating a large decrease in NOₓ conversion activity upon aging. This shows how N₂O formation by a copper zeolite catalyst can be decreased by decreasing the copper loading, but the trade-off is low catalytic stability. When 0.44 mmol/g of magnesium or zinc is added to the formulation containing 0.25 mmol/g of copper, the formation of N₂O is further decreased. Furthermore, addition of magnesium or zinc eliminates the gap in NOₓ conversion between the degreened and aged catalysts. In fact, the samples containing additional magnesium or zinc show a slight increase in NOₓ conversion activity after aging, indicated by ΔdeNOₓ values less than zero. The formulation containing 0.44 mmol/g of copper shows a similar response in N₂O selectivity and enhanced catalytic stability when 0.25 mmol of magnesium or zinc are added. The formulation containing 0.50 mmol/g of copper shows increased catalytic stability when 0.19 mmol/g of magnesium or zinc are added, but there is only a small response in the N₂O selectivity. At 0.63 mmol/g of copper, the residual ion-exchange capacity in tetrahedral sites T₍₂₋₄₎ is only 0.06 mmol/g, which limits the amount of additional magnesium or zinc that can be added before copper is displaced from these sites. In this case, the amount of copper alone is sufficient to insure high catalytic stability. Addition of 0.06 mmol/g magnesium or zinc does not lead to any decrease in N₂O formation, and the N₂O formation by the sample containing 0.63 mmol/g of copper is even increased by addition of magnesium or zinc. This data illustrates how the addition of a divalent metal species like magnesium or zinc into residual ion-exchange sites of a copper zeolite can be used to improve the performance and selectivity of the catalyst for selective catalytic reduction when the copper loading is not high enough to compensate all the high-density ion exchange sites (i.e T₍₂₋₄₎ sites). As the copper loading in mequiv/g approaches the ion-exchange capacity in TD sites, the ability to improve performance by adding additional metal ions is diminished.

TABLE 1

| | | | | Additional |
|---|---|---|---|---|
| | | Copper | | metal |
| Sample | exchange | loading | Additional | loading |
| ID | process | (mmol/g) | metal | (mmol/g) |
| B1 | Example 1 | 0.25 | — | — |
| C2 | Example 2 | 0.25 | Mg | 0.15 |
| C3 | Example 3 | 0.25 | Mg | 0.15 |
| C4 | Example 4 | 0.25 | Mg | 0.15 |
| D2 | Example 2 | 0.25 | Mg | 0.30 |
| D3 | Example 3 | 0.25 | Mg | 0.30 |
| D4 | Example 4 | 0.25 | Mg | 0.30 |
| E2 | Example 2 | 0.25 | Mg | 0.45 |
| E3 | Example 3 | 0.25 | Mg | 0.45 |
| E4 | Example 4 | 0.25 | Mg | 0.45 |
| F2 | Example 2 | 0.25 | Zn | 0.15 |
| F3 | Example 3 | 0.25 | Zn | 0.15 |
| F4 | Example 4 | 0.25 | Zn | 0.15 |
| G2 | Example 2 | 0.25 | Zn | 0.30 |
| G3 | Example 3 | 0.25 | Zn | 0.30 |
| G4 | Example 4 | 0.25 | Zn | 0.30 |
| H2 | Example 2 | 0.25 | Zn | 0.45 |
| H3 | Example 3 | 0.25 | Zn | 0.45 |
| H4 | Example 4 | 0.25 | Zn | 0.45 |

TABLE 2

| | | | | Additional | |
|---|---|---|---|---|---|
| | | Copper | | metal | combined |
| Sample | exchange | loading | Additional | loading | M²⁺ |
| ID | process | (mmol/g) | metal | (mmol/g) | (mmol/g) |
| C4 | Example 7 | 0.25 | Mg | 0.15 | 0.40 |
| D4 | Example 7 | 0.25 | Mg | 0.30 | 0.55 |
| E4 | Example 7 | 0.25 | Mg | 0.44 | 0.69 |
| J4 | Example 7 | 0.25 | Mg | 0.56 | 0.81 |
| K4 | Example 7 | 0.25 | Mg | 0.68 | 0.93 |
| L4 | Example 7 | 0.25 | Mg | 0.80 | 1.05 |
| F4 | Example 8 | 0.25 | Zn | 0.15 | 0.40 |
| G4 | Example 8 | 0.25 | Zn | 0.30 | 0.55 |
| H4 | Example 8 | 0.25 | Zn | 0.44 | 0.69 |
| M4 | Example 8 | 0.25 | Zn | 0.56 | 0.81 |
| N4 | Example 8 | 0.25 | Zn | 0.68 | 0.93 |
| P4 | Example 8 | 0.25 | Zn | 0.80 | 1.05 |

TABLE 3

| | | | Copper | | | | | | |
|---|---|---|---|---|---|---|---|---|---|
| Sample | | Exchange | loading | Magnesium | Zinc | degreened | aged | aged | aged |
| name | SAR | process | (mmol/g) | (mmol/g) | (mmol/g) | 550 C. | 550 C. | 650 C. | 750 C. |
| B21 | 16 | Example 9 | 0.25 | 0 | 0 | x | x | x | x |
| E21 | 16 | Example 9 | 0.25 | 0.44 | 0 | x | x | x | x |
| H21 | 16 | Example 9 | 0.25 | 0 | 0.44 | x | x | x | x |
| S21 | 10 | Example 9 | 0.25 | 0 | 0 | | | x | |
| T21 | 10 | Example 9 | 0.25 | 0.83 | 0 | | | x | |
| U21 | 10 | Example 9 | 0.25 | 0 | 0.83 | | | x | |

TABLE 4

| | | | Copper | | |
|---|---|---|---|---|---|
| Sample | | Exchange | loading | Magnesium | Zinc |
| name | SAR | process | (mmol/g) | (mmol/g) | (mmol/g) |
| V21 | 16 | Example | 0.12 | 0 | 0 |
| | | 10 | | | |
| W21 | 16 | Example | 0.12 | 0.57 | 0 |
| | | 10 | | | |
| X21 | 16 | Example | 0.12 | 0 | 0.57 |
| | | 10 | | | |

TABLE 5

| | | Silica to | | | Additional |
|---|---|---|---|---|---|
| | | Alumina | Copper | | metal |
| Sample | Exchange | Ratio | loading | Additional | loading |
| ID | Process | (SAR) | (mmol/g) | metal | (mmol/g) |
| L30 | Example 12 | 16 | 0.44 | — | — |
| L31 | Example 13 | 16 | 0.44 | Mg | 0.13 |
| L32 | Example 13 | 16 | 0.44 | Mg | 0.25 |
| L33 | Example 13 | 16 | 0.44 | Mg | 0.48 |
| L34 | Example 13 | 16 | 0.44 | Zn | 0.12 |
| L35 | Example 13 | 16 | 0.44 | Zn | 0.23 |
| K30 | Example 16 | 16 | 0.50 | — | — |
| K32 | Example 17 | 16 | 0.50 | Mg | 0.19 |
| K35 | Example 17 | 16 | 0.50 | Zn | 0.19 |
| J30 | Example 14 | 16 | 0.63 | — | — |
| J32 | Example 15 | 16 | 0.63 | Mg | 0.074 |
| J35 | Example 15 | 16 | 0.63 | Zn | 0.061 |

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55%.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 cells refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

1-55. (canceled)

56. A catalyst composition comprising:
a zeolite having:
a total amount of aluminum in sites T(n) with n≥2 of about 0.05 mequiv/g to about 5 mequiv/g, a silica to alumina ratio (SAR) of about 5 to about 120, copper, and at least one additional metal that is not copper,
wherein the additional metal has a charge to radius ratio (Z/r) of about 1.2 to about 3.0, and wherein the metal is not sodium or potassium,
wherein the zeolite has a copper content between about 0.05 mequiv/g and about 5.0 mequiv/g on a Cu2+ basis, and
wherein the copper loading in mequiv/g on a Cu2+ basis is less than the total amount of aluminum equivalents in sites T(n) with n≥2, and wherein, the loading of the additional metal is chosen such that the total metal loading in mequiv/g is less than or equal to the total amount of aluminum equivalents in sites T(n) with n≥1.

57. The catalyst composition of claim 56, wherein the loading of the additional metal is chosen such that the total metal loading in mequiv/g is less than or equal to the total amount of aluminum equivalents in sites T(n) with n≥2.

58. The catalyst composition of claim 56, wherein the copper and at least one additional metal ion are added to the zeolite by an ion-exchange process, or wherein the copper and at least one additional metal ion are added to the zeolite by a co-exchange process.

59. The catalyst composition of claim 56, wherein the additional metal has a charge-to-radius ratio (Z/r) of about 2.0 to 2.5, preferably wherein the additional metal has a charge-to-radius ratio (Z/r) of about 2.2 to about 2.4.

60. The catalyst composition of claim 59, wherein the additional metal comprises magnesium, calcium, strontium, barium, chromium, manganese, iron, cobalt, nickel, zinc, or combinations thereof.

61. The catalyst composition of claim 56, wherein the zeolite has an SAR of about 10 to about 50, preferably wherein the zeolite has an SAR of about 15 to about 40.

62. The catalyst composition of claim 56, wherein the zeolite is a small-pore zeolite, a medium-pore zeolite, or a large-pore zeolite.

63. The catalyst composition of claim 56, wherein the zeolite is a 8-ring zeolite, a 10-ring zeolite or a 12-ring zeolite.

64. The catalyst composition of claim 56, wherein the zeolite has a framework structure selected from AEI, AFT, CHA, LTA, AFX, ERI, UFI, KFI, AFV, AVL, SFW, SWY, or mixtures and/or intergrowths comprising one or more of these, or wherein the zeolite has a framework structure selected from MFI, MWW, FER, MSE, YFI, or mixtures and/or intergrowths comprising one or more of these, or wherein the zeolite has a framework structure selected from FAU, BEA, or mixtures and/or intergrowths comprising one or more of these.

65. The catalyst composition of claim 56, wherein the zeolite is CHA.

66. A method for decreasing the amount of NOₓ in a gas stream which contains NOx, comprising:
contacting the gas stream with a catalyst composition according to claim 56.

67. The method of claim 66, wherein the catalyst composition is coated onto a monolithic substrate in a washcoat layer where the substrate is a metallic, cordierite, or silicon carbide (SiC) substrate.

68. The method of claim 67, wherein the substrate is a flow-through substrate or a wall-flow substrate.

69. The method of claim 66, wherein the amount of the catalyst composition in the washcoat layer is between about 0.1 g/in3 and about 5.0 g/in3 based on the bulk volume of the substrate.

70. An exhaust gas treatment system comprising:
an NOx generator which produces an exhaust gas stream containing NOx,
a catalyst composition according to claim 56.

71. The exhaust gas treatment system of claim 70, wherein the NOx generator is an internal combustion engine, an external combustion engine, or a chemical reactor.

72. The exhaust gas treatment system of claim 70, wherein the catalyst composition is in a close-coupled position.

73. The exhaust gas treatment system of claim 70, wherein the catalyst composition is coated onto a monolithic substrate in a washcoat layer where the substrate is a metallic, cordierite, or silicon carbide (SiC) substrate.

74. The exhaust gas treatment system of claim 73, wherein the substrate is a flow-through substrate or a wall-flow substrate.

75. The exhaust gas treatment system of claim 73, wherein the amount of the catalyst composition in the washcoat layer is between about 0.1 g/in3 and about 5.0 g/in3 based on the bulk volume of the substrate.
